(19) United States
(12) Patent Application Publication
(10) Pub. No.: US 2026/0270590 A1
(43) Pub. Date: Sep. 10, 2026

(54) DETECTION OF OVERLAPPING FRAMES

(71) Applicant: QUALCOMM Incorporated, San Diego, CA (US)

(72) Inventors: Anuj Kumar GUPTA, Bangalore (IN); Alok Kumar PANDEY, Hyderabad (IN); Sujith SHIVALINGAPPA, Bengaluru (IN)

(21) Appl. No.: 19/075,449

(22) Filed: Mar. 10, 2025

(51) Int. Cl. H04N 25/76; H04N 25/767

(52) U.S. Cl. CPC H04N 25/7795; H04N 25/767

(57) ABSTRACT

Aspects presented herein relate to methods and devices for communication including an apparatus, e.g., an SoC. The apparatus may obtain an indication of a start of a frame including a set of lines, wherein the set of lines is associated with frame processing for the frame. The apparatus may also monitor for a timing window between an EOL of a current line in the set of lines and a, SOL of a subsequent line in the set of lines within the frame. Further, the apparatus may detect that a length of the timing window between the EOL of the current line and the SOL of the subsequent line is greater than a threshold time. The apparatus may also output an indication that the length of the timing window between the EOL of the current line and the SOL of the subsequent line is greater than the threshold time.

### TECHNICAL FIELD

The present disclosure relates generally to communication systems, and more particularly, to communication systems with devices with a safety monitor.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a system-on-chip (SoC), a camera serial interface (CSI) receiver, an application processor (AP), a safety monitor, a safety controller, a controller, a safety system, a safety component, an automotive component, an automotive system, a system, a component, or any apparatus that may perform communication. The apparatus may configure a length of a timing window between an end-of-line (EOL) of a current line and a start-of-line (SOL) of the subsequent line. The apparatus may also obtain an indication of a start of a frame including a set of lines, where the set of lines is associated with frame processing for the frame. The apparatus may also obtain an indication of the EOL of the current line in the set of lines; and initiate a timer for the length of the timing window upon obtainment of the indication of the EOL of the current line. The apparatus may also monitor for a timing window between an end-of-line (EOL) of a current line in the set of lines and a start-of-line (SOL) of a subsequent line in the set of lines within the frame, where the subsequent line is after the current line in the set of lines. Additionally, the apparatus may detect that a length of the timing window between the EOL of the current line and the SOL of the subsequent line is greater than a threshold time. The apparatus may also output an indication that the length of the timing window between the EOL of the current line and the SOL of the subsequent line is greater than the threshold time. Moreover, the apparatus may obtain an indication of the SOL of the subsequent line in the set of lines; and stop a timer for the length of the timing window based on the indication of the SOL of the subsequent line in the set of lines. The apparatus may also determine that a quality level of the frame is below a suitable quality level; and output an indication that the quality level of the frame is below the suitable quality level based on the timing window between the EOL of the current line and the SOL of the subsequent line being greater than the threshold time. The apparatus may also obtain an indication to reset the frame processing based on the timing window between the EOL of the current line and the SOL of the subsequent line being greater than the threshold time.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example processing for various components in accordance with one or more techniques of this disclosure.

FIG. 5 is a diagram illustrating an example of a vehicle performing road object detection in accordance with one or more techniques of this disclosure.

FIG. 6 is a diagram illustrating an example of a vehicle performing a map over-the-air process in accordance with one or more techniques of this disclosure.

FIG. 7 is a diagram illustrating an example of a globally distributed switch controller (GDSC) and global distributed head switches (GDHS) in accordance with one or more techniques of this disclosure.

FIG. 8 is a diagram illustrating an example of frame timeline in accordance with one or more techniques of this disclosure

FIG. 9 is a diagram illustrating an example of frame timeline in accordance with one or more techniques of this disclosure.

FIG. 10 is a diagram illustrating an example frame detection process in accordance with one or more techniques of this disclosure.

FIG. 11 is a diagram illustrating an example frame detection process in accordance with one or more techniques of this disclosure.

FIG. 12 is a diagram illustrating an example frame timeline in accordance with one or more techniques of this disclosure.

FIG. 13 is a diagram illustrating an example frame detection process in accordance with one or more techniques of this disclosure.

FIG. 14 is a communication flow diagram illustrating example communications between a system-on-chip (SoC), a component (e.g., an automotive component), and a memory in accordance with one or more techniques of this disclosure.

FIG. 15 is a flowchart of an example method of communication in accordance with one or more techniques of this disclosure.

FIG. 16 is a flowchart of an example method of communication in accordance with one or more techniques of this disclosure.

FIG. 17 is a diagram illustrating an example of a hardware implementation for an example apparatus and/or network entity in accordance with one or more techniques of this disclosure.

### DETAILED DESCRIPTION

Camera sensor data transmissions may experience abrupt stops and starts due to interference and link instability. This may result in a pattern where a start of frame (SOF) is received, followed by M lines of data, and then an interruption. The data transmission may resume with N lines, and then conclude with an end of frame (EOF). Then, for some time in between, there may be no data being passed and the data lines may be sitting idle. This may be referred to as a vertical blocking interval (VBI), which is the time between the end of the final visible line of a frame or field and the beginning of the first visible line of the next frame or field. Frames may overlap (or be stitched together) with other frames. For example, two frames may overlap with each other (or be stitched together), and from a receiver point of view, they may be treated as a single frame, which is an overlapped frame scenario where the first frame is overlapping with a third frame or any next N number of frames. But from application point of view, this may be the same frame. In an actual scenario, these frames may be captured in a two different time scenarios. The combined size of the first and second parts of the stitched or overlapped frame may be equal to, less than, or greater than the original frame. In applications (e.g., camera applications), the sensor data may abruptly stop due to external electrostatic interference or any electrical interference or due to external noise. The abrupt stops and starts in the camera sensor data transmission may end up causing interruptions in the frame transmissions. This may lead to a catastrophic safety event for the computer vision algorithm and result in visually imperfect frames for applications (e.g., an application that is consuming the frames) relying on camera data thus failing in maintain data integrity. So a catastrophic safety event may be due to overlapping frames in certain applications along with the corresponding interruptions in camera sensor data transmission. As such, in order to prevent a catastrophic safety event, it may be beneficial to provide for an early detection mechanism for overlapping frames and/or interruptions in the frame transmission.

Aspects of the present disclosure may include a number of benefits or advantages. For instance, aspects of the present disclosure may provide for an early detection mechanism for incoming frames. For example, aspects presented herein may provide for an early detection mechanism for overlapping frames. That is, aspects presented herein may allow an SoC or a camera serial interface (CSI) receiver in an SoC to utilize an early detection mechanism for overlapping frames. For instance, aspects presented herein may monitor incoming frames with an SoC or a camera serial interface (CSI) receiver to detect potentially overlapping frames. Moreover, aspects presented herein may provide an early detection for interruptions in the frame transmission. That is, aspects presented herein may allow an SoC or a camera serial interface (CSI) receiver in an SoC to utilize an early detection mechanism for interruptions in the frame transmission. For instance, aspects presented herein may monitor incoming frames with an SoC or a camera serial interface (CSI) receiver to detect potential interruptions in the frame transmission. By doing so, this may prevent any catastrophic safety events for the computer vision algorithms that result in visually imperfect frames for applications. This may allow a camera or vehicle (e.g., an SoC or CSI receiver) to avoid any catastrophic safety events for the computer vision algorithms that result in visually imperfect frames for applications. Further, aspects presented herein may optimize the functionality of a camera or vehicle (e.g., an SoC or CSI receiver). In turn, this may optimize or improve the overall performance of a camera or vehicle (e.g., an SoC or CSI receiver).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

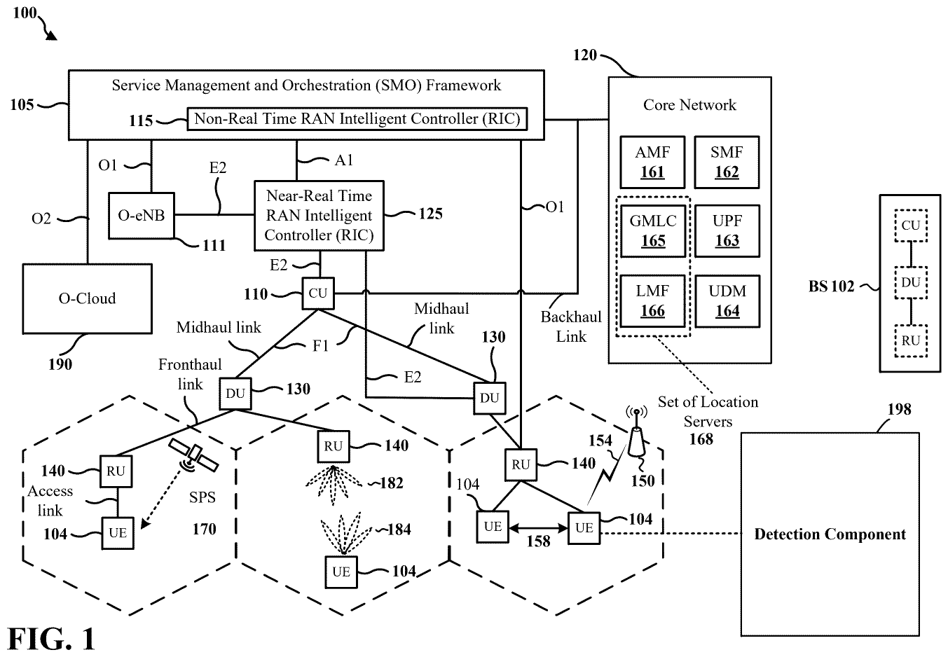

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN

Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a detection component 198. In some aspects, the detection component 198 may be configured to obtain an indication of a start of a frame including a set of lines, where the set of lines is associated with frame processing for the frame. The detection component 198 may also be configured to monitor for a timing window between an end-of-line (EOL) of a current line in the set of lines and a start-of-line (SOL) of a subsequent line in the set of lines within the frame, where the subsequent line is after the current line in the set of lines. The detection component 198 may also be configured to configure the length of the timing window between the EOL of the current line and the SOL of the subsequent line. The detection component 198 may also be configured to detect that a length of the timing window between the EOL of the current line and the SOL of the subsequent line is greater than a threshold time. The detection component 198 may also be configured to output an indication that the length of the timing window between the EOL of the current line and the SOL of the subsequent line is greater than the threshold time. The detection component 198 may also be configured to obtain an indication of the EOL of the current line in the set of lines; and initiate a timer for the length of the timing window upon obtainment of the indication of the EOL of the current line. The detection component 198 may also be configured to obtain an indication of the SOL of the subsequent line in the set of lines; and stop a timer for the length of the timing window based on the indication of the SOL of the subsequent line in the set of lines. The detection component 198 may also be configured to determine that a quality level of the frame is below a suitable quality level; and output an indication that the quality level of the frame is below the suitable quality level based on the timing window between the EOL of the current line and the SOL of the subsequent line being greater than the threshold time. The detection component 198 may also be configured to obtain an indication to reset the frame processing based on the timing window between the EOL of the current line and the SOL of the subsequent line being greater than the threshold time. Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

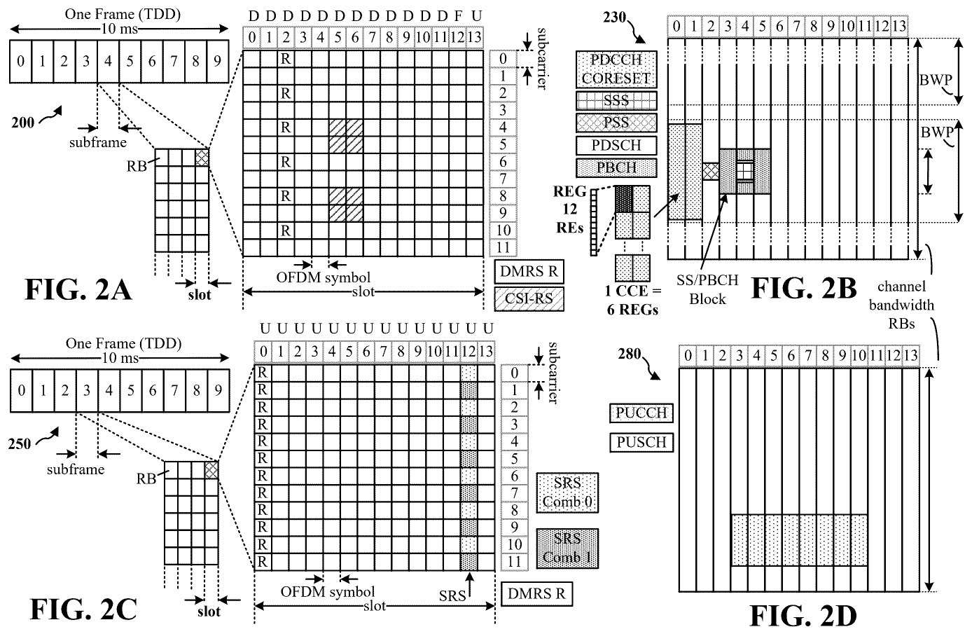

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

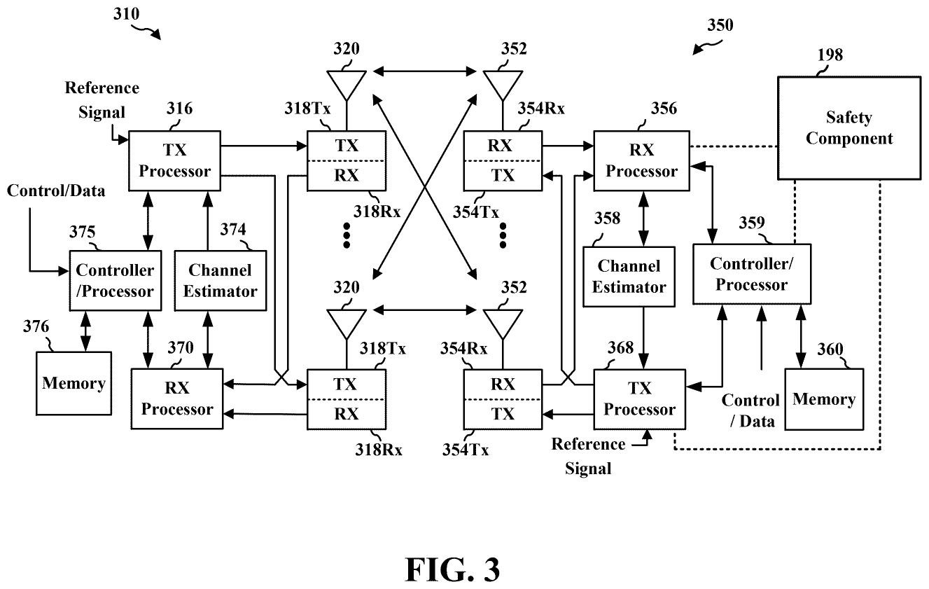

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with detection component 198 of FIG. 1.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

In some aspects, a display device may present frames at different frame rates on the first display panel and the second display panel. For instance, a display panel may present frames at 60 frames per second (FPS) on both the first display panel and the second display panel, 45 FPS on both the first display panel and the second display panel, etc. The display device may synchronize frame rates of content with refresh rates of the display panels (via a vertical synchronization process, which may be referred to as vsync, Vsync, VSync, or VSYNC). For instance, content may be available at 60 FPS and the first display panel and the second display panel may have a refresh rate of 95 Hz. Via Vsync, the refresh rate of the first display panel and the second display panel may be set to 60 Hz to match the 60 FPS content.

As indicated herein, VSync is a graphics technology that synchronizes the frame rate of an application/game with a refresh rate at a display (e.g., a display on a client device). Vsync may be utilized as a manner in which to deal with screen tearing (i.e., the screen displays portions of multiple frames at once). That can result in the display appearing to be split along a line. Tearing may occur when the display refresh rate (i.e., how many times the display updates per second) is not in synchronization with the frames per second (FPS). VSync signals may synchronize the display pipeline (e.g., the pipeline including application rendering, compositor, and a hardware composer (HWC) that presents images on the display). For instance, VSync signals may help to synchronize the time in which applications wake up to start rendering, the time the compositor wakes up to composite the screen, and the display refresh cycle. This synchronization may help to eliminate display refresh issues and improve visual performance. In some examples, the HWC may generates VSync events/signals and send the events/signals to the compositor.

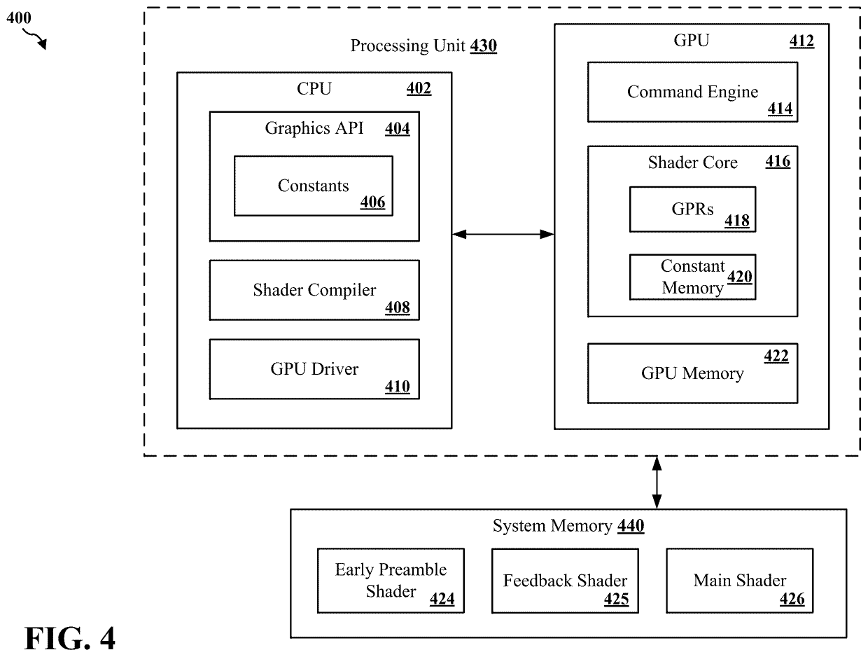

FIG. 4 is a diagram 400 that illustrates processing components, such as a processing unit 430 and the system memory 440, as may be identified in connection with a device for processing data. In aspects, the processing unit 430 may include a CPU 402 and a GPU 412. The GPU 412 and the CPU 402 may be formed as an integrated circuit (e.g., a system-on-a-chip (SOC)) and/or the GPU 412 may be incorporated onto a motherboard with the CPU 402. Alternatively, the CPU 402 and the GPU 412 may be configured as distinct processing units that are communicatively coupled to each other. For example, the GPU 412 may be incorporated on a graphics card that is installed in a port of the motherboard that includes the CPU 402.

The CPU 402 may be configured to execute a software application that causes graphical content to be displayed (e.g., on a display(s) of a device) based on one or more operations of the GPU 412. The software application may issue instructions to a graphics application program interface (API) 404, which may be a runtime program that translates instructions received from the software application into a format that is readable by a GPU driver 410. After receiving instructions from the software application via the graphics API 404, the GPU driver 410 may control an operation of the GPU 412 based on the instructions. For example, the GPU driver 410 may generate one or more command streams that are placed into the system memory 440, where the GPU 412 is instructed to execute the command streams (e.g., via one or more system calls). A command engine 414 included in the GPU 412 is configured to retrieve the one or more commands stored in the command streams. The command engine 414 may provide commands from the command stream for execution by the GPU 412. The command engine 414 may be hardware of the GPU 412, software/firmware executing on the GPU 412, or a combination thereof. While the GPU driver 410 is configured to implement the graphics API 404, the GPU driver 410 is not limited to being configured in accordance with any particular API. The system memory 440 may store the code for the GPU driver 410, which the CPU 402 may retrieve for execution. In examples, the GPU driver 410 may be configured to allow communication between the CPU 402 and the GPU 412, such as when the CPU 402 offloads graphics or non-graphics processing tasks to the GPU 412 via the GPU driver 410.

The system memory 440 may further store source code for one or more of an early preamble shader 424, a feedback shader 425, or a main shader 426. In such configurations, a shader compiler 408 executing on the CPU 402 may compile the source code of the shaders 424-426 to create object code or intermediate code executable by a shader core 416 of the GPU 412 during runtime (e.g., at the time when the shaders 424-426 are to be executed on the shader core 416). In some examples, the shader compiler 408 may pre-compile the shaders 424-426 and store the object code or intermediate code of the shader programs in the system memory 440. The shader compiler 408 (or in another example the GPU driver 410) executing on the CPU 402 may build a shader program with multiple components including the early preamble shader 424, the feedback shader 425, and the main shader 426. The main shader 426 may correspond to a portion or the entirety of the shader program that does not include the early preamble shader 424 or the feedback shader 425. The shader compiler 408 may receive instructions to compile the shader(s) 424-426 from a program executing on the CPU 402. The shader compiler 408 may also identify constant load instructions and common operations in the shader program for including the common operations within the early preamble shader 424 (rather than the main shader 426). The shader compiler 408 may identify such common instructions, for example, based on (presently undetermined) constants 406 to be included in the common instructions. The constants 406 may be defined within the graphics API 404 to be constant across an entire draw call. The shader compiler 408 may utilize instructions such as a preamble shader start to indicate a beginning of the early preamble shader 424 and a preamble shader end to indicate an end of the early preamble shader 424. Similar instructions may be used for the feedback shader 425 and the main shader 426. The feedback shader 425 will be described in further detail below.

The shader core 416 included in the GPU 412 may include general purpose registers (GPRs) 418 and constant memory 420. The GPRs 418 may correspond to a single GPR, a GPR file, and/or a GPR bank. Each GPR in the GPRs 418 may store data accessible to a single thread. The software and/or firmware executing on GPU 412 may be a shader program 424-426, which may execute on the shader core 416 of GPU 412. The shader core 416 may be configured to execute many instances of the same instructions of the same shader program in parallel. For example, the shader core 416 may execute the main shader 426 for each pixel that defines a given shape. The shader core 416 may transmit and receive data from applications executing on the CPU 402. In examples, constants 406 used for execution of the shaders 424-426 may be stored in a constant memory 420 (e.g., a read/write constant RAM) or the GPRs 418. The shader core 416 may load the constants 406 into the constant memory 420. In further examples, execution of the early preamble shader 424 or the feedback shader 425 may cause a constant value or a set of constant values to be stored in on-chip memory such as the constant memory 420 (e.g., constant RAM), the GPU memory 422, or the system memory 440. The constant memory 420 may include memory accessible by all aspects of the shader core 416 rather than just a particular portion reserved for a particular thread such as values held in the GPRs 418.

In recent years, vehicle manufacturers have been developing vehicles with assisted driving and/or autonomous driving capabilities. Assisted driving, which may also be called advanced driver assistance systems (ADAS), may refer to a set of technologies designed to enhance vehicle safety and improve the driving experience by providing assistance and automation to the driver. These technologies may use various sensor(s), such as camera(s), ranging devices(s), etc., and other components to monitor a vehicle's surroundings and assist the driver of the vehicle with certain driving tasks. For example, some features of assisted driving systems may include: (1) adaptive cruise control (ACC) (e.g., a system that automatically adjusts a vehicle's speed to maintain a safe following distance from the vehicle ahead), (2) lane-keeping assist (LKA) (e.g., a system that uses cameras to detect lane markings and helps keep the vehicle centered within the lane, and provides steering inputs to prevent unintentional lane departure), (3), autonomous emergency braking (AEB) (e.g., a system that detects potential collisions with obstacles or pedestrians and automatically apply the brakes to avoid or mitigate the impact), (4) blind spot monitoring (BSM) (e.g., a system that uses sensors to detect vehicles in a driver's blind spots and provides visual or audible alerts to avoid potential collisions during lane changes), (5) parking assistance (e.g., a system that assists drivers in parking their vehicles by using camera(s) and sensor(s) to help with parallel parking or maneuvering into tight spaces), and/or traffic sign recognition (e.g., camera(s) and image processing are used to recognize and display traffic signs such as speed limits, stop signs, and other road regulations on the vehicle's dashboard).

Autonomous driving, which may also be called as self-driving or driverless technology, may refer to the ability of a vehicle to navigate and operate itself without specifying human intervention (e.g., travelling from one place to another place without a human controlling the vehicle). The goal of the autonomous driving is to create vehicles that are capable of perceiving their surroundings, making decisions, and controlling their movements, all without the direct involvement of a human driver. To achieve or improve the autonomous driving, a vehicle may be specified to use a map (or map data) with detailed information, such as a high-definition (HD) map. An HD map may refer to a highly detailed and accurate digital map designed for use in autonomous driving and ADAS. In one example, HD maps may typically include one or more of: (1) geometric information (e.g., precise road geometry, including lane boundaries, curvature, slopes, and detailed 3D models of the surrounding environment), (2) lane-level information (e.g., information about individual lanes on the road, such as lane width, lane type (e.g., driving, turning, or parking lanes), and lane connectivity), (3) road attributes (e.g., data on road features like traffic signs, signals, traffic lights, speed limits, and road markings), (4) topology (e.g., information about the relationships between different roads, intersections, and connectivity patterns), (5) static objects (e.g., locations and details of fixed objects along the road, such as buildings, traffic barriers, and poles), (6) dynamic objects (e.g., real-time or frequently updated data about moving objects, like other vehicles, pedestrians, and cyclists), and/or (7) localization and positioning: precise reference points and landmarks that help in accurate vehicle localization on the map, etc.

Note while some assisted/autonomous driving systems may demand the use of HD map data, there are also assisted/autonomous driving systems and information systems that may be configured not to use HD map data (e.g., due to costs). For example, the Society of Automotive Engineers (SAE) has defined six levels of driving automation, from Level 0 (no automation) to Level 5 (full automation). For Level 0 (no automation), the human driver may be responsible for all aspects of driving, and the system may provide warnings or momentary assistance but does not take control of the vehicle. Example features for SAE Level 0 may include automatic emergency braking, blind spot warnings, and lane departure warnings, etc. As such, SAE Level 0 may not specify using HD map data. For Level 1 (driver assistance), the vehicle may assist with either steering or acceleration/deceleration (but may not perform both simultaneously). The human driver is still responsible for most driving tasks and may need to be ready to take over at any time. Example features for SAE Level 1 may include adaptive cruise control or lane-keeping assistance (e.g., lane centering), etc. For Level 2 (partial automation), the vehicle may control both steering and acceleration/deceleration under certain conditions, but the human driver is requested to remain engaged and monitor the driving environment at all times. Example features for SAE Level 2 may include ADAS, adaptive cruise control and lane-keeping assistance at the same time, etc. For Level 3 (conditional automation), the vehicle may perform all driving tasks under specific conditions, and the human driver may not be specified to monitor the environment but may need to be ready to take over when requested by the system. Example features for SAE Level 3 may include traffic jam chauffeur, where the vehicle is capable of handling driving in traffic jams without driver intervention. For Level 4 (high automation), the vehicle is capable of handling all driving tasks within certain conditions or environments (geofenced areas). The system may operate without human intervention but may specify a human driver outside its operational domain. Example features for SAE Level 4 may include local driverless taxi and pedals/steering, etc. For Level 5 (full automation), the vehicle is capable of performing all driving tasks under all conditions, and does not specify the human driver at any time. Example features for SAE Level 5 may include fully autonomous vehicles with no steering wheel or pedals. In summary, SAE Level 0 may be defined as features to provide warnings and assistance. ADAS is usually SAE Level 1 and 2, while AD is considered SAE level 3 to 5. Aspects presented herein (described below) may apply to all levels of SAE, including SAE Level 0 (e.g., for speed warning). For purposes of the present disclosure, a system or information system that is used in associated with SAE Level 0 to Level 5 may collectively be referred to as a “vehicle system,” which may encompass the assisted driving and the autonomous driving.

To enable a vehicle to be capable of providing assisted driving and/or autonomous driving, the vehicle may be configured to use various machine learning (ML) and/or neural network (NN) frameworks. An ML/NN framework may refer to a set of tools, libraries, and/or software components that are configured to provide a structured way to design, build, and deploy ML/NN models and applications. These frameworks may be able to simplify the process of developing ML/NN algorithms and applications by providing a foundation of pre-built functions, algorithms, and utilities. They may typically include features for data preprocessing, model training, evaluation, and/or deployment, etc. ML/NN frameworks may come in various programming languages, and they may be configured to cater to different types of machine learning tasks, including supervised learning, unsupervised learning, and/or reinforcement learning, etc. An ML/NN model may refer to a mathematical representation of a real-world process or problem, created using ML/NN algorithms and techniques. These ML/NN models may be configured to make predictions, classify data, and/or solve specific tasks based on patterns and relationships learned from input data. A deep learning framework may refer to a specialized software library or toolset that provides specified components and abstractions for building, training, and deploying deep neural networks. Deep learning frameworks may be designed to facilitate the development of complex neural network models, especially deep neural networks with multiple layers. These frameworks may offer a wide range of pre-implemented layers, optimizers, loss functions, and other components, making it easier for researchers and developers to work with deep learning models.

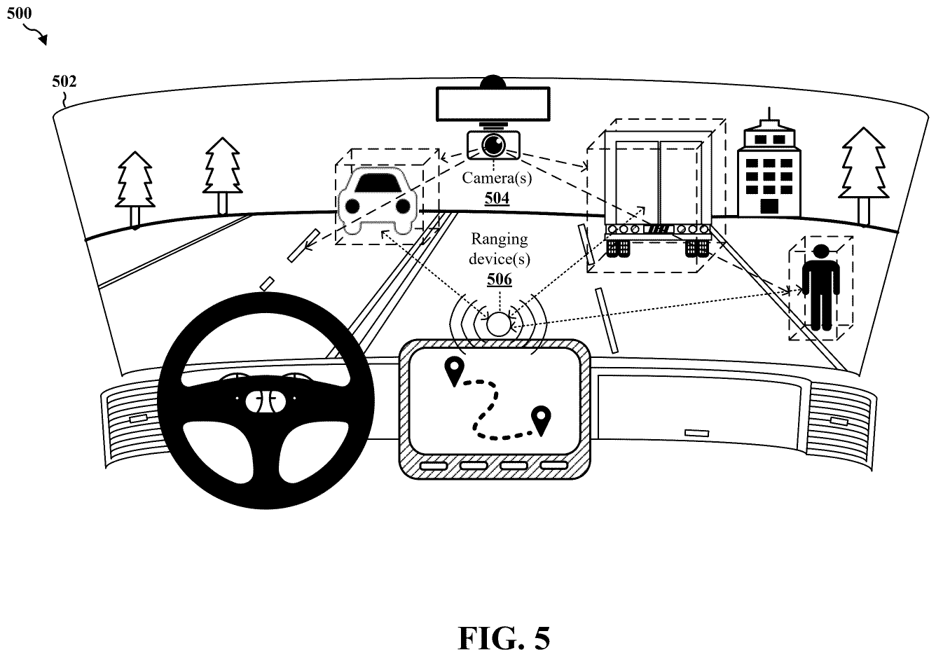

FIG. 5 is a diagram 500 illustrating an example of a vehicle performing road object detection using different types of sensors in accordance with various aspects of the present disclosure. In some implementations, a vehicle system may be configured to perform road object detections using multiple types of sensors (and also one or more ML/NN models). For purposes of the present disclosure, a road object or a traffic participant may refer to an object that is related to roads and driving, and is typically/commonly used/considered by the vehicle system in providing assisted driving or performing autonomous driving. In some examples, the road object/traffic participant may also be referred to as a traffic-related object. For example, a road object/traffic participant may be another vehicle, a pedestrian, a cyclist/bicycle, an animal, a traffic cone, a traffic sign, a traffic light, traffic, a traffic lane, a traffic line, a vulnerable road user (VRU), an object that is within a threshold distance of the vehicle, and/or any objects that may typically present on the roads (e.g., on the driving paths of vehicles), etc. On the other hand, a non-road object or a non-traffic participant (which may also be referred to as a non-traffic related object) may refer to an object that is not related to roads and driving, and is typically/commonly not used/considered by the vehicle system in providing assisted driving or performing autonomous driving. For example, a non-road object/non-traffic participant may be an object that is not within a threshold distance of the vehicle (e.g., a house on the side of the road, a mountain that is far away), an object that is not typically presented on a driving path/road (a flying object, a fire hydrant, a tree, etc.), a structure that is typically not traversed by vehicles (e.g., a pedestrian bridge), etc. An ML/NN model may be trained to identify whether an object is a road object or a non-road object.

For example, as shown by the diagram 500, a vehicle or a vehicle system (collectively as a “UE 502”) may be configured to use different types of sensors, such as a set of cameras 504 and/or a set of ranging devices 506 for detecting road objects. For purposes of the present disclosure, the term “ranging device” may broadly refer to a device/component that is capable of detecting at least the presence and/or the distance of a physical object. Examples of ranging devices may include an RF ranging device, a sonar, an ultrasonic sensor, a light detection and ranging device, etc. In some implementations, the UE 502 may also use different MN/NN models for identifying different types of road objects. For example, a first ML/NN model may be trained/used to detect and track polylines from sensor output(s) (e.g., images captured by the camera(s) of the vehicle, point clouds generated from ranging devices, etc.), while a second ML/NN model may be trained/used to detect and track objects in a three-dimensional (3D) space (e.g., to perform 3D object detection (3DOD) tasks). Then, the outputs of different types of sensors (e.g., from the set of cameras 504 and the set of ranging devices 506) may be processed and used by the ADAS or the autonomous driving system (e.g., for assisted/autonomous driving). A point cloud may refer to a discrete set of data points in space, where these points may represent a 3D shape or object. In some implementations, each point position may be associated with a set of Cartesian coordinates (X, Y, Z). Point clouds may be produced by ranging devices by detecting multiple points on the external surfaces of objects.

As described in connection with FIG. 5, various applications (e.g., use cases) such as assisted driving and/or autonomous driving, may specify the use of map data. To keep the map data up-to-date, these applications (or devices running these applications) may be configured to download updated map data from a server from time to time or based on certain pre-defined conditions (e.g., when travelling to an area that is without map data). In some implementations, downloading map data from a server may be referred to as “map over the air” (MOTA).

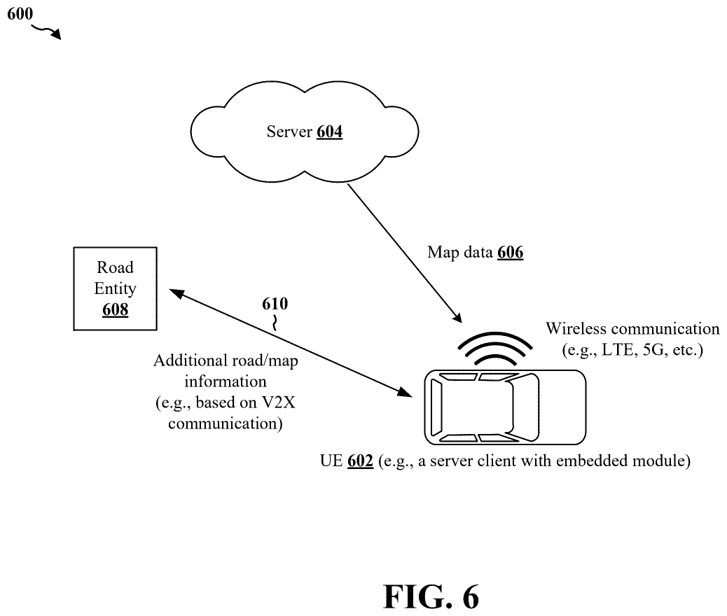

FIG. 6 is a diagram 600 illustrating an example of a vehicle performing map over the air in accordance with various aspects of the present disclosure. In one example, map over the air may refer to a process of a server 604 sending (real-time) map data 606 to a UE 602 (e.g., a vehicle, a vehicle system, an on-board unit (OBU) of the vehicle, a device running a navigation application, etc.) over a wireless network/communication (e.g., an LTE network, a 5G network, etc.), enabling the UE 602 to make decisions based on the latest information about the road and traffic conditions. Depending on implementations and conditions, different amount of map data 606 may be downloaded by the UE 602 from the server 604. For example, in some scenarios, the UE 602 may be configured to (1) download map data before driving, (2) download just updates for road conditions (e.g., traffic jams, construction work, etc.) while driving, (3) continuously download updated map data whenever available, or (4) a combination thereof (e.g., the UE 602 may download map data before driving, and continuously to download the updates while driving, including changes in map data (e.g., newly opened or closed street/highway, short term construction work). In some scenarios, the UE 602 may also be configured to stream the map data 606, which means the UE 602 does not download the map data before driving (e.g., the map data is streamed in real-time while the UE 602 is driving).

In an example implementation, the map data 606 is transmitted from the server 604 (e.g., a cloud-based system), where the server 604 may utilize sensors and other data sources to collect and analyze information about the road network and traffic patterns. For example, the server 604 may receive and gather traffic/road information provided by a group of UEs (e.g., vehicles, roadside units (RSUs), etc.). In some examples, the information/data collected by a server from multiple UEs may be referred to as “fleet data” or “crowdsourced/crowdsourcing data.” This data may be processed and combined with other data, such as GPS/GNSS and/or camera data from multiple users (e.g., from other UEs/vehicles and/or the UE 602) to create a detailed map of the environment in real-time. Then, an application (e.g., for autonomous driving, navigation, positioning, etc.) of the UE 602 may access the map data 606 over a wireless network (e.g., a cellular or satellite network), and use the map data 606 to make decisions about speed, route, and other factors, etc. For example, the UE 602 may use the map data 606 to avoid road construction, traffic congestion, or accidents, and to optimize its route for efficiency and safety, etc. In some examples, as shown at 610, the UE 602 may also be configured to receive (additional) road/map information from another road entity 608, such as from another vehicle/UE, a roadside unit (RSU), or a traffic/road infrastructure (e.g., traffic lights), such as based on vehicle-to-everything (V2X) communication protocol/technology.

Map data with lane-level information, such as road-maps with lane-level connectivity, may play an important role in enhancing the safety, the efficiency, and/or the overall performance of autonomous driving systems and ADAS systems, and may also contribute to the realization of a safer and more connected transportation future. For purposes of the present disclosure, a map data with lane-level information/connectivity may be referred to as a “lane-map,” a “lane-level map,” “lane-map data,” and/or “lane-level map data,” etc., which may indicate that the map data includes information related to different lanes of a road. In addition, depending on the context, the term “map data” may be used interchangeably with the term “map.”

As used herein, the term “processing core” or “BIST core” may refer to a unit within a processing unit (e.g., a CPU or a GPU) that performs computation and processes instructions where each core may independently execute tasks by reading and executing program instructions. Each processing core may all have access to a memory, such as a cache, which may store data. As used herein, the term “cluster,” “a set of processing cores,” or “a subset of processing cores,” may refer to a group of processing cores that share some resources, such as cache memory or power management features. The clusters may communicate with each other, via a high-speed interconnect or bus, to share data across the entire CPU, which may enable coordinated multitasking. A particular processing core or a set of processing cores may be “functional,” which may be operational and fully capable of executing instructions, handling tasks, and performing computations. A particular processing core or a set of processing cores may be “non-functional,” which may be disabled, faulty, in a standby mode, or otherwise unable to execute certain instructions. In some aspects, a device may fuse or completely turn off non-functional cores or underperforming cores. As used herein, the term “bypass” may refer to skipping BIST when other cores are subject to BIST. As used herein, the term “built-in self-test (BIST)” may refer to a scheme that enables a component, such as a CPU or a GPU, to test itself automatically without external testing equipment. BIST may generate test patterns or stimuli and then apply these to various parts of the component (e.g., logic gates, memory cells, interconnections) to check for issues, such as non-functional processing cores. In some aspects, a BIST may involve multi-phase tests.

System-on-chips (SoCs or SOCs) may be mainly a multi-processing core. The concept of fusing or completely turning off non-functional cores or underperforming cores may be a process used for ensuring SoC performance. A built-in self-test (BIST) may be enabled for identifying non-functional cores. In general, a hardware control unit where sequences may be encoded from the start based on power on configuration at a hardware BIST control unit (HBCU). The HBCU may generate phase-wise control signals based on the sequences. Based on the boot core and boot cluster information, each BIST core may be mapped to corresponding phase signals. Mask signals may be generated based on which BIST core may be subject to disable or fuse. Logic BIST (LBIST) memory BIST (MBIST) gating based on the mask signals may be used to handle a toggle rate. BIST pass/fail status generation may be based on disable/fuse, boot core, and boot cluster values. The disable/fuse values may represent which cores to disable/fuse, the boot core values may represent which cores may be used for booting, and the boot cluster values may represent the programmable value stored in fuses associated with a specific cluster of cores.

Globally distributed switch controller (GDSC) is a hardware controller to collapse/wakeup a power switchable core in the correct sequence of assertion/de-assertion of controls and with configurable delays between different steps of the sequence. The controller provides signals to control the clocks, resets, retention of registers and memories, isolations and power switches in the core. GDSC is placed inside a clock controller block. Separate controllers are used for power gating of logic and memories. Global distributed head switches (GDHS) are a grid of power switches used for power gating, placed inside the GDHS hard macro (HM). These grid of GDHS switches are controlled from GDSC controller and controls are provided to switches in a daisy-chained fashion to avoid inrush current issues. There are generally separate controller/switches for logic and memory portions of design within a core. Memory power controls are also staggered to handle inrush current issues for large memory banks. A daisy-chain may refer to a topology where components (e.g., switches, registers, or gates) are connected in series, with the output of one component feeding into the input of the next. For the GDHS switches, the output signal of one switch may serve as the input to the next so that the activation or deactivation of the switches follows a specific order or sequence. Daisy-chaining the switches ensures that the power-gating sequence is controlled step by step.

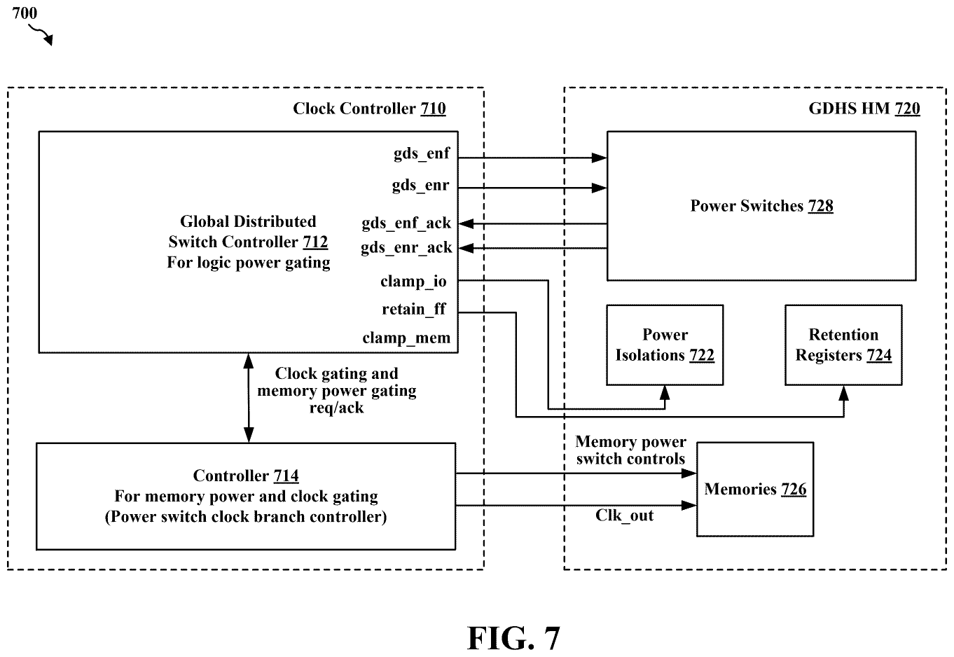

FIG. 7 is a diagram 700 illustrating an example of a globally distributed switch controller (GDSC) and global distributed head switches (GDHS). As illustrated in FIG. 7, clock controller 710, which may include a GDSC 712 for logic power gating connected to a controller 714 for memory power and clock gating (power switch clock branch controller), may be connected to a GDHS HM 720, which includes a set of power switches 728 (which may be daisy-chained), a set of power isolations 722 (e.g., for isolating signals during transitions), a set of retention registers 724 (e.g., retains some data during power-down states), and memories 726. The GDSC 712 may communicate various signals with the GDHS HM 720. For example, the GDSC 712 may provide gds_enf for enabling force signal for power gating and gds_enr for enabling release signal for power gating to the set of power switches 728, and receive associated acknowledgment signals gds_enf_ack for acknowledgment of gds_enf and gds_enr_ack for acknowledgment of gds_enr. The GDSC 712 may also provide clamp_io which manages I/O clamping for isolation to the set of power isolations 722. The GDSC 712 may also provide retain_ff to the set of retention registers 724 which retains flip-flop states during power gating. The GDSC 712 may also provide clamp_mem which indicates clamps memory signals for isolation to the memories 726. The controller 714 may provide memory power switch controls and a clock to the memories 726.

Driving systems for vehicles (e.g., autonomous driving systems) may include a number of circuits or components. For instance, driving systems may include a system-on-chip (SoC), which is an integrated circuit that may integrate most or all of the components of a computer system or electronic system. These components in the system may include an on-chip central processing unit (CPU), memory interfaces, input/output devices and interfaces, and/or secondary storage interfaces. An SoC may also include other components, such as modems and a graphics processing unit (GPU). SoCs may also contain digital functions, analog functions, mixed-signal functions, and/or signal processing functions. An SoC may also integrate a microcontroller, a microprocessor, or several processor cores with peripherals (e.g., a GPU, Wi-Fi and cellular network radio modems, and/or one or more processors). Additionally, an SoC may integrate a microcontroller with advanced peripherals. Compared to a multi-chip architecture, an SoC with equivalent functionality may have reduced power consumption.

In addition, driving systems for vehicles may include an electronic control unit (ECU), which may also be referred to as an electronic control module (ECM). An ECU is an embedded system in automotive electronics that may control one or more of the electrical systems or subsystems in a vehicle. An ECU's main function may be to keep the engine working smoothly. For example, an ECU may control everything in the engine, including the wheel speed, braking power, ignition timing, idle speed, the air/fuel mixture, etc. On vehicles with an electronic fuel injection, an ECU may control the amount of fuel that enters the engine's cylinders. Modern vehicles have a number of different ECUs, which can include one or more of: an ECM, a powertrain control module (PCM), a transmission control module (TCM), a brake control module (BCM), a central control module (CCM), a central timing module (CTM), a general electronic module (GEM), a body control module (BCM), and a suspension control module (SCM). These ECUs may be referred to as a vehicle's computer, although technically they are all separate computers. An ECU may also include one or more SoCs. Some modern vehicles may have a large number of ECUs (e.g., up to 150 ECUs). Further, software may be embedded in ECUs. Managing the increasing complexity and number of ECUs in a vehicle is a challenge for original equipment manufacturers (OEMs). Also, automated driving may include certain technologies (e.g., advanced driver-assistance systems (ADAS) technologies) that assist drivers with the safe operation of a vehicle. Through a human-machine interface, these features (e.g., ADAS features) may increase car and road safety. ADAS features may use automated technology, such as sensors and cameras, to detect nearby obstacles or driver errors, and respond accordingly. ADAS features may enable various levels of autonomous driving.

Automotive systems may experience a number of potential issues. For example, if hardware freezes or gets stuck in an error state (e.g., there is an error in some pipeline and the camera hardware is stuck), software may need to issue a reset in order to reset the hardware. For instance, software may issue a camera service extension (CSE) receive (RX)/image signal processing (ISP) reset. However, in some instances, hardware cannot be reset independently. For instance, issuing the CSE RX/ISR reset for error handling may be expensive as it may need software intervention to reset the hardware. So anytime hardware is reset (e.g., camera hardware), there may also be a need to reset a sensor. As a result, the automotive system may need to turn off the sensor and then restart the sensor. This can take a lot of time, which may lead to frame loss. So this is an expensive process and software does not want to perform this process. What software expects is that somehow the hardware should be able to recover without having to having them issue a reset.

Certain types of camera data may be associated with different packets or frames. For instance, Mobile Industry Processor Interface (MIPI) camera serial interface 2 (CSI2) data (e.g., a camera stream) may consist of a short packet for start of frame (SoF), end of frame (EoF), start of line (SOL) and end of line (EOL) related information. MIPI CSI2 data may also include a long packet for frame payload data. A line may be defined by long packet between start of transmission (SoT) and end of transmission (EoT). The time between an EoT of line N and a SoT of line N+1 may be referred to as a horizontal blanking interval (HBI) or line blanking. A frame may be defined by the lines between frame start (FS) short packet and a frame end (FE) short packet. The time between a FE of frame N and a FS of frame N+1 may be referred to as a vertical blanking interval (VBI) or frame blanking. The camera sensor may transmit embedded headers and footers along with image data to convey image-specific information such as frame number and frame cyclic redundancy check (CRC). The header may be towards the SOF and the footer may be towards the EOF, with the image data situated between the header and footer. A camera sensor may send embedded and image data with a same virtual channel (VC) but different data time (DT), packed with single FE and FS. For example, the camera sensor may send data to a system on-chip (SoC) in a device (e.g., a vehicle). For instance, within a vehicle, an SoC may have multiple cameras that are connected to it. So a camera within a vehicle may send information to an SoC within that vehicle.

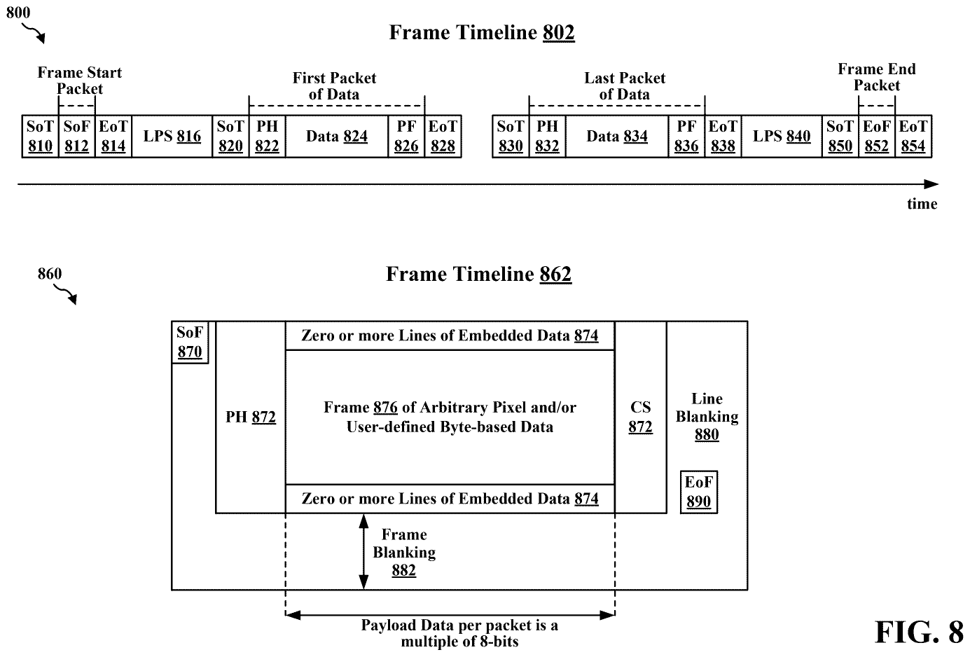

FIG. 8 is a diagram 800 illustrating an example frame timeline. More specifically, diagram 800 depicts an example frame timeline 802 and diagram 860 depicts an example frame timeline 862. As shown in FIG. 8, diagram 800 includes frame timeline 802 including start of transmission (SoT) 810, start of frame (SoF) 812, end of transmission (EoT) 814, low power state (LPS) 816, SoT 820, packet header (PH) 822, data 824, packet footer (PF) 826, EoT 828, SoT 830, PH 832, data 834 PF 836, EoT 838, LPS 840, SoT 850, EoF 852, and EoT 854. As depicted in FIG. 8, there is also a frame start packet near SoF 812, a first packet of data near data 824, a last packet of data near data 834, and a frame end packet near EoF 852. As shown in FIG. 8, diagram 860 includes frame timeline 862 including SoF 870, PH 872, zero or more lines of embedded data 874, frame 876 of arbitrary pixel and/or user-defined byte-based data, checksum (CS) 872, line blanking 880, frame blanking 882, and EoF 890. Diagram 860 also shows a payload data per packet is a multiple of 8-bits. FIG. 8 depicts the different aspects of frames (e.g., camera frames) that can be in frame timeline 802 and frame timeline 862.

Camera sensor data transmissions may experience abrupt stops and starts due to interference and link instability. This may result in a pattern where a start of frame (SOF) is received, followed by M lines of data, and then an interruption. The data transmission may resume with N lines, and then conclude with an end of frame (EOF). Then, for some time in between, there may be no data being passed and the data lines may be sitting idle. This may be referred to as a vertical blocking interval (VBI), which is the time between the end of the final visible line of a frame or field and the beginning of the first visible line of the next frame or field. Frames may overlap (or be stitched together) with other frames. For example, two frames may overlap with each other (or be stitched together), and from a receiver point of view, they may be treated as a single frame, which is an overlapped frame scenario where the first frame is overlapping with a third frame or any next N number of frames. But from application point of view, this may be the same frame. In an actual scenario, these frames may be captured in a two different time scenarios. The combined size of the first and second parts of the stitched or overlapped frame may be equal to, less than, or greater than the original frame. In applications (e.g., camera applications), the sensor data may abruptly stop due to external electrostatic interference or any electrical interference or due to external noise. The abrupt stops and starts in the camera sensor data transmission may end up causing interruptions in the frame transmissions. This may lead to a catastrophic safety event for the computer vision algorithm and result in visually imperfect frames for applications (e.g., an application that is consuming the frames) relying on camera data thus failing in maintain data integrity. So a catastrophic safety event may be due to overlapping frames in certain applications along with the corresponding interruptions in camera sensor data transmission. As such, in order to prevent a catastrophic safety event, it may be beneficial to provide for an early detection mechanism for overlapping frames and/or interruptions in the frame transmission.

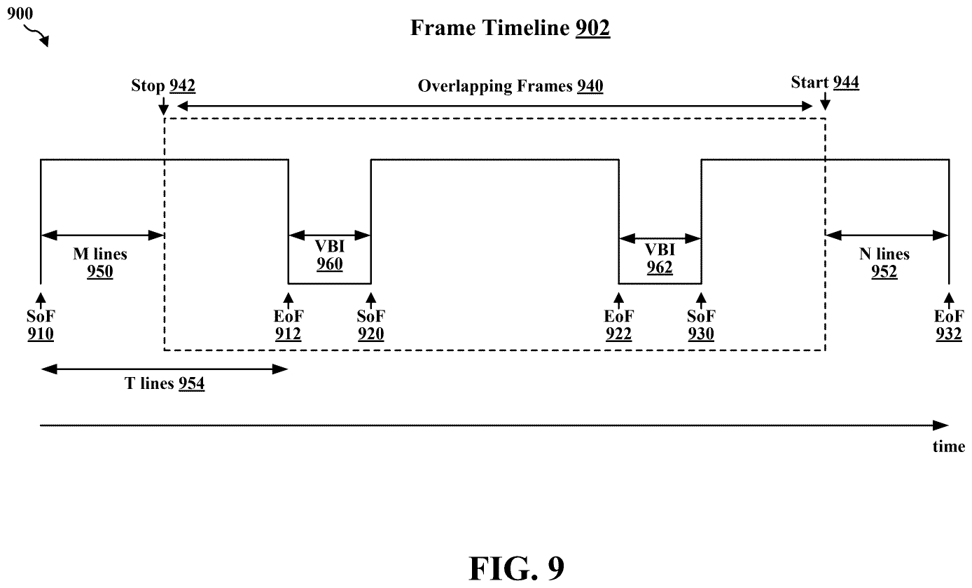

FIG. 9 is a diagram 900 illustrating an example frame timeline. More specifically, diagram 900 depicts an example frame timeline 902. As shown in FIG. 9, diagram 900 includes frame timeline 902 including SoF 910, EoF 912, SoF 920, EoF 922, SoF 930, and EoF 932. Diagram 900 also includes overlapping frames 940, stop 942, start 944, M lines 950, N lines 952, T lines 954, VBI 960 and VBI 962. As shown in FIG. 9, overlapping frames 940 may be two frames that overlap with each other, and from a receiver point of view, they may be treated as a single frame. From application point of view, this may be the same frame. In an actual scenario, these overlapping frames 940 may be captured in a two different time scenarios. The combined size of the first and second parts of the overlapping frames 940 may be equal to, less than, or greater than the original frame. In applications (e.g., camera applications), the sensor data may abruptly stop 942 due to external electrostatic interference or any electrical interference or due to external noise, and then start 944. The abrupt stop 942 and start 944 in the camera sensor data transmission may end up causing interruptions in the frame transmissions. This may lead to a catastrophic safety event for the computer vision algorithm and result in visually imperfect frames for applications (e.g., an application that is consuming the frames) relying on camera data thus failing in maintain data integrity. So a catastrophic safety event may be due to overlapping frames in certain applications along with the corresponding interruptions in camera sensor data transmission. As shown in FIG. 9, in order to prevent a catastrophic safety event, it may be beneficial to provide for an early detection mechanism for overlapping frames and/or interruptions in the frame transmission.

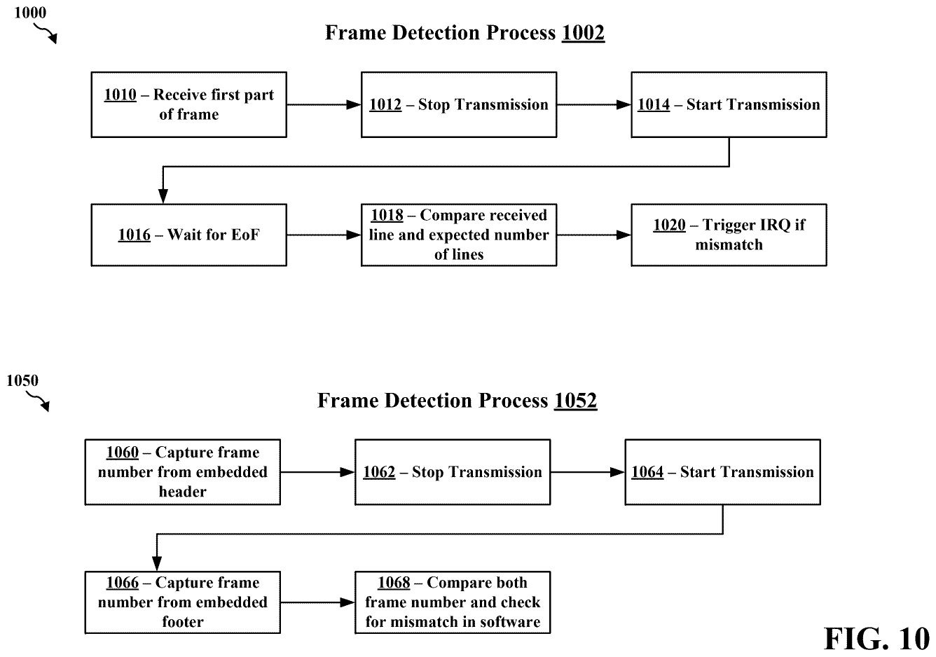

FIG. 10 is a diagram 1000 illustrating an example frame detection process. More specifically, diagram 1000 depicts an example frame detection process 1002 and diagram 1050 depicts an example frame detection process 1052. As shown in FIG. 10, diagram 1000 includes frame detection process 1002 including a number of steps. At 1010, a first part of a frame may be received. At 1012, a transmission may stop. At 1014, a transmission may start. At 1016, an EoF may be waited for. At 1018, there may be a comparison of a received line and an expected number of lines. At 1020, an interrupt request (IRQ) may be triggered if there is a mismatch. Diagram 1000 depicts a solution that compares the number of received lines with the expected number and triggers an IRQ at the end of the frame, resulting in delayed detection. This cannot detect if overlapped frame has same number of lines as expected frame. This type of solution determines the frame interruption too late to prevent any potential catastrophic safety events.

As further shown in FIG. 10, diagram 1050 includes frame detection process 1052 including a number of steps. At 1060, a frame number may be captured from an embedded header. At 1062, a transmission may stop. At 1064, a transmission may start. At 1066, a frame number may be captured from an embedded footer. At 1068, there may be a comparison of a frame number and then a check for a mismatch in software. Diagram 1050 depicts a solution that matches the frame number from the header and footer of the same frame to detect mismatches, but due to its dependency on the footer, it waits for the footer to arrive, resulting in delayed detection. This type of solution is ineffective for sensors that do not support sending frame numbers in embedded headers and footers. This type of solution also determines the frame interruption too late to prevent any potential catastrophic safety events.

As indicated above, a catastrophic safety event may be due to overlapping frames in certain applications along with the corresponding interruptions in camera sensor data transmission. As such, in order to prevent a catastrophic safety event, the potentially overlapping frames may need to be detected. Based on the above, it may be beneficial to provide for an early detection mechanism for incoming frames. For instance, it may be beneficial to provide for an early detection mechanism for overlapping frames. Further, it may be beneficial to provide an early detection for interruptions in the frame transmission.

Aspects of the present disclosure may provide for an early detection mechanism for incoming frames. For example, aspects presented herein may provide for an early detection mechanism for overlapping frames. That is, aspects presented herein may allow an SoC or a camera serial interface (CSI) receiver in an SoC to utilize an early detection mechanism for overlapping frames. For instance, aspects presented herein may monitor incoming frames with an SoC or a camera serial interface (CSI) receiver to detect potentially overlapping frames. Moreover, aspects presented herein may provide an early detection for interruptions in the frame transmission. That is, aspects presented herein may allow an SoC or a camera serial interface (CSI) receiver in an SoC to utilize an early detection mechanism for interruptions in the frame transmission. For instance, aspects presented herein may monitor incoming frames with an SoC or a camera serial interface (CSI) receiver to detect potential interruptions in the frame transmission. By doing so, this may prevent any catastrophic safety events for the computer vision algorithms that result in visually imperfect frames for applications. This may allow a camera or vehicle (e.g., an SoC or CSI receiver) to avoid any catastrophic safety events for the computer vision algorithms that result in visually imperfect frames for applications. Further, aspects presented herein may optimize the functionality of a camera or vehicle (e.g., an SoC or CSI receiver). In turn, this may optimize or improve the overall performance of a camera or vehicle (e.g., an SoC or CSI receiver).

Aspects presented herein may utilize an SoC or a camera serial interface (CSI) receiver in an SoC to monitor incoming frames (e.g., potentially overlapping frames) in order to prevent any catastrophic safety events for the computer vision algorithms that result in visually imperfect frames for applications. In the camera module, there is a transmitter part that sends the data, and in the SoC there is a receiver (e.g., the CSI receiver) which receives the data, and then decodes the packets. Aspects herein may utilize the camera serial interface (CSI) receiver (e.g., the CSI receiver within the SoC) can monitor the horizontal blanking interval (HBI) using a timer and expose a configurable maximum HBI interval. So within the SoC, aspects herein may utilize the CSI receiver to monitor (e.g., monitor using a timer) the HBI for frames that are being sent from the camera. For instance, aspects herein may utilize a CSI receiver to monitor the frames from a camera module and/or monitor the HBI interval. If the HBI exceeds a threshold maximum value (e.g., a programmed maximum value, such as 10 μs), the CSI receiver may trigger an interrupt (e.g., interrupt to be sent to the CPU) when the timer expires. For example, if the HBI is detected to be greater than a threshold value (e.g., 10 μs), the SoC (within hardware at the device) can send an interrupt (e.g., an interrupt request (IRQ)) to the CPU (e.g., software running on the CPU that is controlling an application running on the CPU). This interrupt may inform the CPU that the data transmission has stopped and the HBI monitoring has failed. So if the HBI exceeds a threshold maximum value, this means that a current camera frame has been dropped and the camera frame data has stopped being transmitted.

Aspects herein may also monitor a vertical blanking interval (VBI), so a CSI receiver in an SOC may monitor the VBI interval or set a VBI timer. The aforementioned procedure (e.g., monitoring an HBI/VBI at a CSI receiver or utilizing an HBI or VBI timer) may help in the early detection of dropped frames and software can tag the overlapped frame and reset the hardware. After a reset, the hardware (e.g., the SoC) can latch onto the next received start of frame (SOF) and resume receiving, resulting in zero loss of good frames. Aspects herein may provide for an early detection of potentially overlapping frames. For instance, aspects herein may detect if overlapped frames have a same number of lines as an expected frame. By doing so, aspects herein may determine or detect any frame interrupts early enough to prevent any potentially catastrophic errors. Aspects herein may also be effective for sensors that do not support sending frame numbers in embedded headers and footers. That is, aspects herein may provide for an early detection of potentially overlapping frames and/or potential frame interrupts.

Aspects presented herein (e.g., an SoC or CSI receiver) may obtain an indication of a start of a frame including a set of lines, where the set of lines is associated with frame processing for the frame. Aspects presented herein (e.g., an SoC or CSI receiver) may also monitor for a timing window between an end-of-line (EOL) of a current line in the set of lines and a start-of-line (SOL) of a subsequent line in the set of lines within the frame, where the subsequent line is after the current line in the set of lines. Aspects presented herein (e.g., an SoC or CSI receiver) may also configure the length of the timing window between the EOL of the current line and the SOL of the subsequent line. Additionally, aspects presented herein (e.g., an SoC or CSI receiver) may detect that a length of the timing window between the EOL of the current line and the SOL of the subsequent line is greater than a threshold time. Aspects presented herein (e.g., an SoC or CSI receiver) may also output an indication that the length of the timing window between the EOL of the current line and the SOL of the subsequent line is greater than the threshold time. Aspects presented herein (e.g., an SoC or CSI receiver) may also obtain an indication of the EOL of the current line in the set of lines; and initiate a timer for the length of the timing window upon obtainment of the indication of the EOL of the current line. Moreover, aspects presented herein (e.g., an SoC or CSI receiver) may obtain an indication of the SOL of the subsequent line in the set of lines; and stop a timer for the length of the timing window based on the indication of the SOL of the subsequent line in the set of lines. Aspects presented herein (e.g., an SoC or CSI receiver) may also determine that a quality level of the frame is below a suitable quality level; and output an indication that the quality level of the frame is below the suitable quality level based on the timing window between the EOL of the current line and the SOL of the subsequent line being greater than the threshold time. Aspects presented herein (e.g., an SoC or CSI receiver) may also obtain an indication to reset the frame processing based on the timing window between the EOL of the current line and the SOL of the subsequent line being greater than the threshold time.

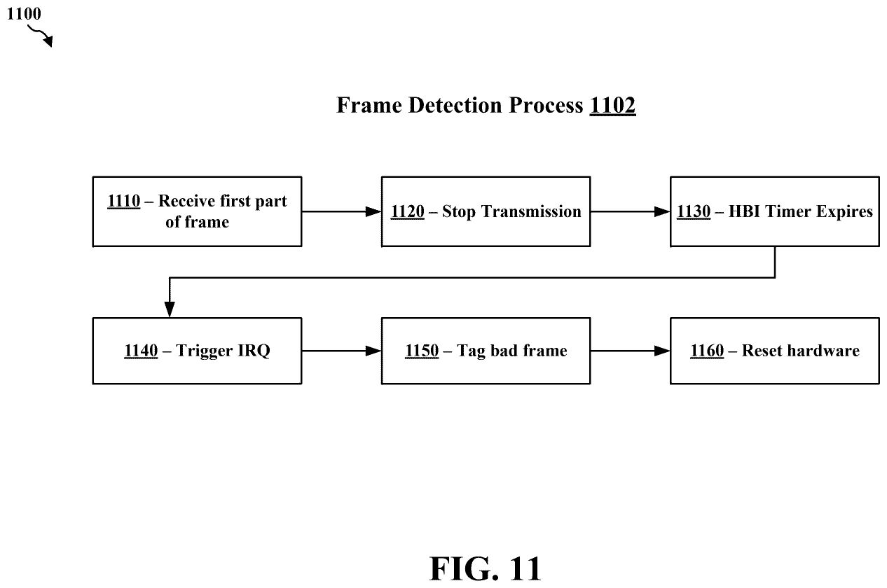

FIG. 11 is a diagram 1100 illustrating an example frame detection process. More specifically, diagram 1100 depicts an example frame detection process 1102. As shown in FIG. 11, diagram 1100 includes frame detection process 1102 including a number of steps. At 1110, aspects herein (e.g., an SoC or CSI receiver) may receive a first part of a frame. At 1120, aspects herein (e.g., an SoC or CSI receiver) may stop a transmission. At 1130, aspects herein (e.g., an SoC or CSI receiver) may detect that an HBI timer has expired. At 1140, aspects herein (e.g., an SoC or CSI receiver) may trigger an IRQ. At 1150, aspects herein (e.g., an SoC or CSI receiver) may tag a bad frame (e.g., a frame that is not suitable quality). At 1160, aspects herein (e.g., an SoC or CSI receiver) may reset the hardware. Frame detection process 1102 depicts that aspects herein (e.g., an SoC or CSI receiver) may provide for an early detection of potentially overlapping frames. For instance, aspects herein (e.g., an SoC or CSI receiver) may detect if overlapped frames have a same number of lines as an expected frame. By doing so, aspects herein (e.g., an SoC or CSI receiver) may determine or detect any frame interrupts early enough to prevent any potentially catastrophic errors. Aspects herein (e.g., an SoC or CSI receiver) may also be effective for sensors that do not support sending frame numbers in embedded headers and footers. That is, aspects herein (e.g., an SoC or CSI receiver) may provide for an early detection of potentially overlapping frames and/or potential frame interrupts.

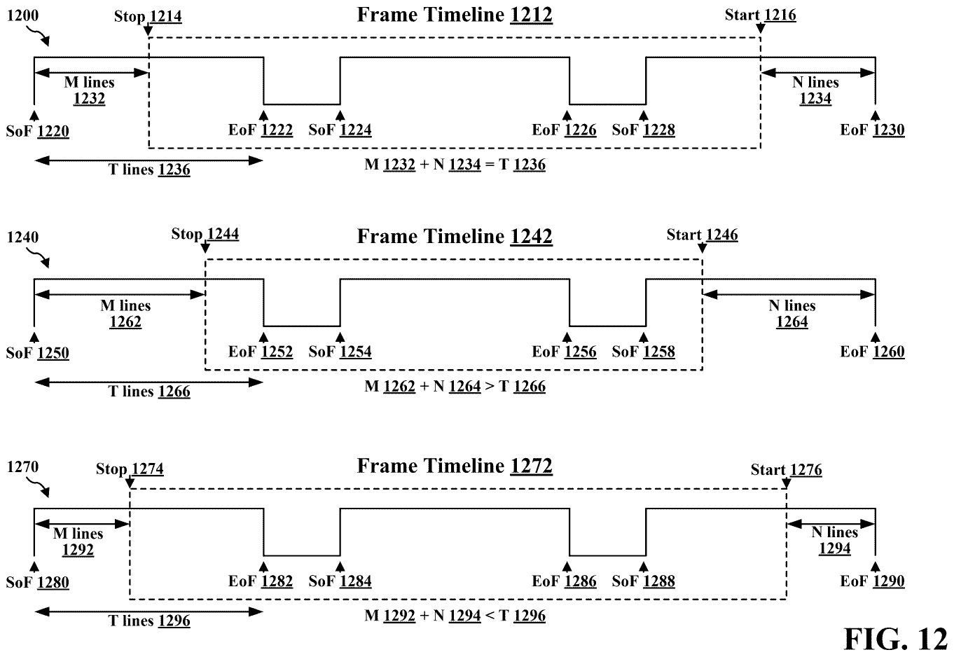

FIG. 12 is a diagram 1200 illustrating an example frame timeline. More specifically, diagram 1200 depicts an example frame timeline 1212, diagram 1240 depicts an example frame timeline 1242, and diagram 1270 depicts an example frame timeline 1272. As shown in FIG. 12, diagram 1200 includes overlapping frames including stop 1214 and start 1216, SoF 1220, EoF 1222, SoF 1224, EoF 1226, SoF 1228, and EoF 1230. Diagram 1200 also includes M lines 1232, N lines 1234, T lines 1236. As shown in diagram 1200, M lines 1232+N lines 1234=T lines 1236. That is, diagram 1200 depicts that a transmission stops in middle of a frame and a stitched frame size (e.g., an overlapping frame size) is the same as an expected frame. Aspects herein may detect this early (i.e., detect that a transmission stops in middle of a frame) and close to the transmission stop when an HBI timer expires. Aspects herein may also reset hardware and start reception from a next SOF.

As further shown in FIG. 12, diagram 1240 includes overlapping frames including stop 1244 and start 1246, SoF 1250, EoF 1252, SoF 1254, EoF 1256, SoF 1258, and EoF 1260. Diagram 1240 also includes M lines 1262, N lines 1264, T lines 1266. As shown in diagram 1240, M lines 1262+N lines 1264>T lines 1266. That is, diagram 1240 depicts that a transmission stops in middle of a frame and a stitched frame size (e.g., an overlapping frame size) is more than expected frame. Aspects herein may detect this early (i.e., detect that a transmission stops in middle of a frame) and close to the transmission stop when an HBI timer expires. Aspects herein may also reset hardware and start reception from a next SOF.

As further shown in FIG. 12, diagram 1270 includes overlapping frames including stop 1274 and start 1276, SoF 1280, EoF 1282, SoF 1284, EoF 1286, SoF 1288, and EoF 1290. Diagram 1270 also includes M lines 1292, N lines 1294, T lines 1296. As shown in diagram 1270, M lines 1292+N lines 1294<T lines 1296. That is, diagram 1270 depicts that a transmission stops in middle of a frame and a stitched frame size (e.g., an overlapping frame size) is less than expected frame. Aspects herein may detect this early (i.e., detect that a transmission stops in middle of a frame) and close to the transmission stop when an HBI timer expires. Aspects herein may also reset hardware and start reception from a next SOF.

Aspects presented herein may detect problem scenarios early, such as close to a frame data transmission stop event (e.g., 10 us after the frame data transmission has stopped), rather than waiting until near an EoF event to detect the issue. For instance, aspects herein may cover a variety of sensors and all possible error scenarios. That is, aspects herein may help in early detection of error and recovery and can result in almost losing zero good frames, which is important in a safe subsystem environment. So aspects herein may increase the reliability and safety of devices (e.g., vehicles) that utilize camera data transmissions. For example, aspects herein can help to make vehicles safer due to the early detection of frame data transmission failures. Also aspects herein may utilize a CSI receiver to monitor the HBI using a timer and expose a configurable maximum HBI interval. If the HBI exceeds the programmed maximum value, the CSI receiver may trigger an interrupt to the CPU when the timer expires.

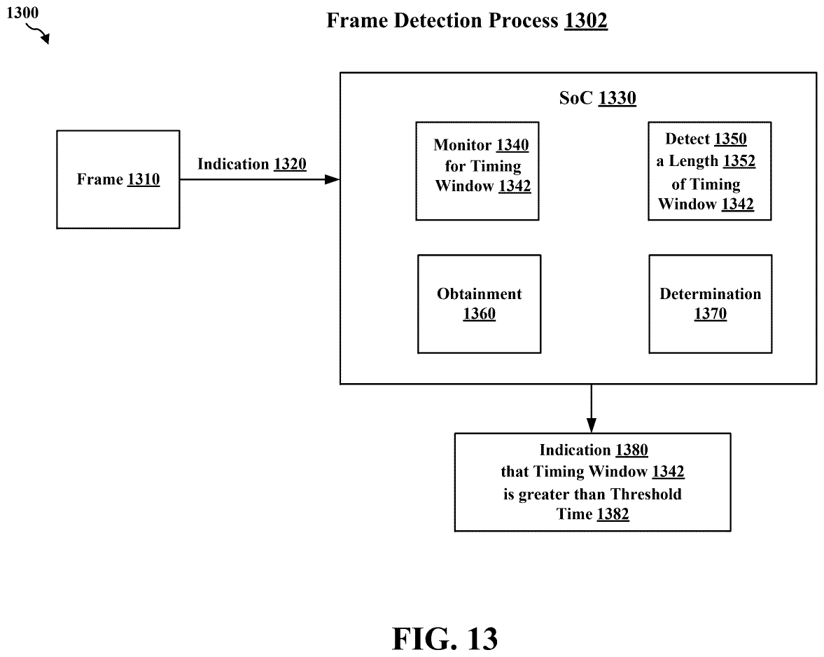

FIG. 13 illustrates diagram 1300 including one example of a frame detection process. More specifically, diagram 1300 depicts an example frame detection process 1302 for an SoC or a vehicle. As shown in FIG. 13, diagram 1300 includes frame 1310, indication 1320, SoC 1330, monitor 1340, timing window 1342, detect 1350, length 1352 of timing window 1342, obtainment process 1360, determination process 1370, indication 1380, and threshold time 1382. As shown in FIG. 13, SoC 1330 may obtain an indication 1320 of a start of a frame 1310 including a set of lines, where the set of lines is associated with frame processing for the frame. SoC 1330 may also monitor 1340 for a timing window 1342 between an end-of-line (EOL) of a current line in the set of lines and a start-of-line (SOL) of a subsequent line in the set of lines within the frame, where the subsequent line is after the current line in the set of lines. SoC 1330 may also configure the length 1352 of the timing window 1342 between the EOL of the current line and the SOL of the subsequent line. Additionally, SoC 1330 may detect that a length 1352 of the timing window 1342 between the EOL of the current line and the SOL of the subsequent line is greater than a threshold time 1382. SoC 1330 may also output an indication 1380 that the length 1352 of the timing window 1342 between the EOL of the current line and the SOL of the subsequent line is greater than the threshold time 1382. SoC 1330 may also obtain an indication of the EOL of the current line in the set of lines; and initiate a timer for the length 1352 of the timing window 1342 upon obtainment of the indication of the EOL of the current line. Moreover, SoC 1330 may obtain an indication of the SOL of the subsequent line in the set of lines; and stop a timer for the length 1352 of the timing window 1342 based on the indication of the SOL of the subsequent line in the set of lines. SoC 1330 may also determine that a quality level of the frame is below a suitable quality level; and output an indication that the quality level of the frame is below the suitable quality level based on the timing window 1342 between the EOL of the current line and the SOL of the subsequent line being greater than the threshold time 1382. SoC 1330 may also obtain an indication to reset the frame processing based on the timing window 1342 between the EOL of the current line and the SOL of the subsequent line being greater than the threshold time 1382.

Aspects of the present disclosure may include a number of benefits or advantages. For instance, aspects of the present disclosure may provide for an early detection mechanism for incoming frames. For example, aspects presented herein may provide for an early detection mechanism for overlapping frames. That is, aspects presented herein may allow an SoC or a camera serial interface (CSI) receiver in an SoC to utilize an early detection mechanism for overlapping frames. For instance, aspects presented herein may monitor incoming frames with an SoC or a camera serial interface (CSI) receiver to detect potentially overlapping frames. Moreover, aspects presented herein may provide an early detection for interruptions in the frame transmission. That is, aspects presented herein may allow an SoC or a camera serial interface (CSI) receiver in an SoC to utilize an early detection mechanism for interruptions in the frame transmission. For instance, aspects presented herein may monitor incoming frames with an SoC or a camera serial interface (CSI) receiver to detect potential interruptions in the frame transmission. By doing so, this may prevent any catastrophic safety events for the computer vision algorithms that result in visually imperfect frames for applications. This may allow a camera or vehicle (e.g., an SoC or CSI receiver) to avoid any catastrophic safety events for the computer vision algorithms that result in visually imperfect frames for applications. Further, aspects presented herein may optimize the functionality of a camera or vehicle (e.g., an SoC or CSI receiver). In turn, this may optimize or improve the overall performance of a camera or vehicle (e.g., an SoC or CSI receiver).

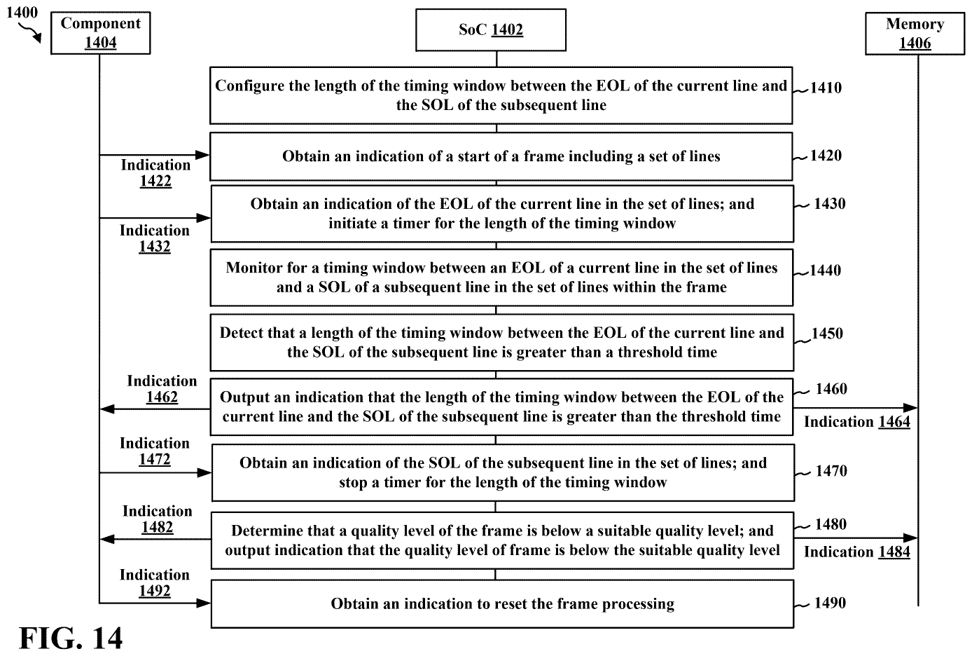

FIG. 14 is a communication flow diagram 1400 illustrating example communication in accordance with one or more techniques of this disclosure. As shown in FIG. 14, diagram 1400 includes example communications between SoC 1402 (e.g., an SoC, a camera serial interface (CSI) receiver, an application processor (AP), a safety monitor, a safety controller, a controller, a safety system, a safety component, an automotive component, an automotive system, a system, a component, or any apparatus that may perform communication, a device (the UE 104, a device that includes the SoC 1402, or the apparatus 1704)), component 1404 (e.g., a safety monitor, a safety controller, a controller, a safety system, a safety component, an automotive component, an automotive system, a system, a component, an SoC, a camera serial interface (CSI) receiver, an application processor (AP), or any apparatus that may perform communication), and memory 1406 (e.g., a memory, a cache, a system memory, a memory or cache at a safety system, or a memory or cache at an automotive system), in accordance with one or more techniques of this disclosure.

At 1410, SoC 1402 may configure the length of the timing window between the EOL of the current line and the SOL of the subsequent line. In some aspects, configuring the length of the timing window may comprise: maintaining the length of the timing window or adjusting the length of the timing window.

At 1420, SoC 1402 may obtain an indication of a start of a frame including a set of lines, where the set of lines is associated with frame processing for the frame. For example, SoC 1402 may obtain indication 1422 from component 1404. In some aspects, obtaining the indication of the frame including the set of lines may comprise: receiving, at a camera serial interface (CSI) receiver in a system-on-chip (SoC), the indication of the frame including the set of lines. Additionally, the frame may be a camera frame in a set of camera frames for a camera, and the camera may be part of a set of cameras that are located within a device or a vehicle. Further, the indication of the start of the frame may be a start-of-frame (SOF) indication or a frame start (FS) indication.

At 1430, SoC 1402 may obtain an indication of the EOL of the current line in the set of lines; and initiate a timer for the length of the timing window upon obtainment of the indication of the EOL of the current line. For example, SoC 1402 may obtain indication 1432 from component 1404. Also, at 1430, SoC 1402 may determine that the timer for the length of the timing window has expired based on the length of the timing window being greater than the threshold time; and reset the timer based on the determination that the timer for the length of the timing window has expired.

At 1440, SoC 1402 may monitor for a timing window between an end-of-line (EOL) of a current line in the set of lines and a start-of-line (SOL) of a subsequent line in the set of lines within the frame, where the subsequent line is after the current line in the set of lines.

At 1450, SoC 1402 may detect that a length of the timing window between the EOL of the current line and the SOL of the subsequent line is greater than a threshold time. In some aspects, detecting that the length of the timing window is greater than the threshold time may comprise: detecting, at a system-on-chip (SoC), that the length of the timing window is greater than the threshold time. Detecting, at the SoC, that the length of the timing window is greater than the threshold time may comprise: detecting, at a camera serial interface (CSI) receiver in the SoC, that the length of the timing window is greater than the threshold time. Further, detecting, at the SoC, that the length of the timing window is greater than the threshold time may comprise: detecting that a timer for the length of the timing window has expired, where a length of the timer is equal to the threshold time. In some aspects, detecting that the timer for the length of the timing window has expired may comprise: determining that an indication of the SOL of the subsequent line is not received within the threshold time. In some instances, the length of the timing window between the EOL of the current line and the SOL of the subsequent line may be a horizontal blanking interval (HBI).

At 1460, SoC 1402 may output an indication that the length of the timing window between the EOL of the current line and the SOL of the subsequent line is greater than the threshold time. In some aspects, outputting the indication that the length of the timing window between the EOL of the current line and the SOL of the subsequent line is greater than the threshold time may comprise: transmitting the indication that the length of the timing window between the EOL of the current line and the SOL of the subsequent line is greater than the threshold time. For example, SoC 1402 may transmit indication 1462 to component 1404. Also, outputting the indication that the length of the timing window between the EOL of the current line and the SOL of the subsequent line is greater than the threshold time may comprise: storing the indication that the length of the timing window between the EOL of the current line and the SOL of the subsequent line is greater than the threshold time. For example, SoC 1402 may store indication 1464 in memory 1406. In some aspects, outputting the indication that the timing window is greater than the threshold time may comprise: sending an interrupt request (IRQ) based on the timing window being greater than the threshold time. Also, sending the IRQ based on the timing window being greater than the threshold time may comprise: transmitting, to a central processing unit (CPU), the IRQ based on the timing window being greater than the threshold time.

At 1470, SoC 1402 may obtain an indication of the SOL of the subsequent line in the set of lines; and stop a timer for the length of the timing window based on the indication of the SOL of the subsequent line in the set of lines. For example, SoC 1402 may obtain indication 1472 from component 1404.

At 1480, SoC 1402 may determine that a quality level of the frame is below a suitable quality level; and output an indication that the quality level of the frame is below the suitable quality level based on the timing window between the EOL of the current line and the SOL of the subsequent line being greater than the threshold time. For example, SoC 1402 may output indication 1482 to component 1404 or output indication 1484 to memory 1406.

At 1490, SoC 1402 may obtain an indication to reset the frame processing based on the timing window between the EOL of the current line and the SOL of the subsequent line being greater than the threshold time. For example, SoC 1402 may obtain indication 1492 from component 1404. Also, at 1490, SoC 1402 may obtain an indication of a start of a subsequent frame including a set of subsequent lines, where the subsequent frame is after the frame; and monitor for a second timing window between an EOL of a second current line in the set of subsequent lines and a SOL of a second subsequent line in the set of subsequent lines, where the second subsequent line is after the second current line in the set of lines.

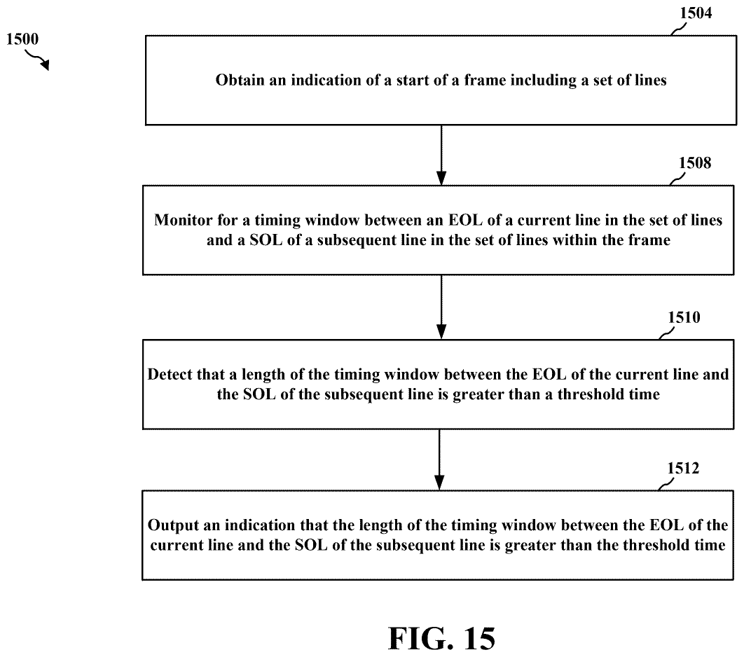

FIG. 15 is a flowchart 1500 of an example method of communication in accordance with one or more techniques of this disclosure. The method may be performed by an SoC (e.g., an SoC, a camera serial interface (CSI) receiver, an application processor (AP), a safety monitor, a safety controller, a controller, a safety system, a safety component, an automotive component, an automotive system, a system, a component, or any apparatus that may perform communication), a device (e.g., the UE 104, a device that includes the SoC 1402, the apparatus 1704), a display driver integrated circuit (DDIC), an apparatus for communication, a wireless communication device, and/or any apparatus that may perform communication as used in connection with the examples of FIGS. 1-14.

At 1504, the SoC may obtain an indication of a start of a frame including a set of lines, where the set of lines is associated with frame processing for the frame, as described in connection with the examples in FIGS. 1-14. For example, as described in 1420 of FIG. 14, SoC 1402 may obtain an indication of a start of a frame including a set of lines, where the set of lines is associated with frame processing for the frame. Further, step 1504 may be performed by detection component 198 in FIG. 1. For example, SoC 1402 may obtain indication 1422 from component 1404. In some aspects, obtaining the indication of the frame including the set of lines may comprise: receiving, at a camera serial interface (CSI) receiver in a system-on-chip (SoC), the indication of the frame including the set of lines. Additionally, the frame may be a camera frame in a set of camera frames for a camera, and the camera may be part of a set of cameras that are located within a device or a vehicle. Further, the indication of the start of the frame may be a start-of-frame (SOF) indication or a frame start (FS) indication.

At 1508, the SoC monitor for a timing window between an end-of-line (EOL) of a current line in the set of lines and a start-of-line (SOL) of a subsequent line in the set of lines within the frame, where the subsequent line is after the current line in the set of lines, as described in connection with the examples in FIGS. 1-14. For example, as described in 1440 of FIG. 14, SoC 1402 may monitor for a timing window between an end-of-line (EOL) of a current line in the set of lines and a start-of-line (SOL) of a subsequent line in the set of lines within the frame, where the subsequent line is after the current line in the set of lines. Further, step 1508 may be performed by detection component 198 in FIG. 1.

At 1510, the SoC detect that a length of the timing window between the EOL of the current line and the SOL of the subsequent line is greater than a threshold time, as described in connection with the examples in FIGS. 1-14. For example, as described in 1450 of FIG. 14, SoC 1402 may detect that a length of the timing window between the EOL of the current line and the SOL of the subsequent line is greater than a threshold time. Further, step 1510 may be performed by detection component 198 in FIG. 1. In some aspects, detecting that the length of the timing window is greater than the threshold time may comprise: detecting, at a system-on-chip (SoC), that the length of the timing window is greater than the threshold time. Detecting, at the SoC, that the length of the timing window is greater than the threshold time may comprise: detecting, at a camera serial interface (CSI) receiver in the SoC, that the length of the timing window is greater than the threshold time. Further, detecting, at the SoC, that the length of the timing window is greater than the threshold time may comprise: detecting that a timer for the length of the timing window has expired, where a length of the timer is equal to the threshold time. In some aspects, detecting that the timer for the length of the timing window has expired may comprise: determining that an indication of the SOL of the subsequent line is not received within the threshold time. In some instances, the length of the timing window between the EOL of the current line and the SOL of the subsequent line may be a horizontal blanking interval (HBI).

At 1512, the SoC output an indication that the length of the timing window between the EOL of the current line and the SOL of the subsequent line is greater than the threshold time, as described in connection with the examples in FIGS. 1-14. For example, as described in 1460 of FIG. 14, SoC 1402 may output an indication that the length of the timing window between the EOL of the current line and the SOL of the subsequent line is greater than the threshold time. Further, step 1512 may be performed by detection component 198 in FIG. 1. In some aspects, outputting the indication that the length of the timing window between the EOL of the current line and the SOL of the subsequent line is greater than the threshold time may comprise: transmitting the indication that the length of the timing window between the EOL of the current line and the SOL of the subsequent line is greater than the threshold time. For example, SoC 1402 may transmit indication 1462 to component 1404. Also, outputting the indication that the length of the timing window between the EOL of the current line and the SOL of the subsequent line is greater than the threshold time may comprise: storing the indication that the length of the timing window between the EOL of the current line and the SOL of the subsequent line is greater than the threshold time. For example, SoC 1402 may store indication 1464 in memory 1406. In some aspects, outputting the indication that the timing window is greater than the threshold time may comprise: sending an interrupt request (IRQ) based on the timing window being greater than the threshold time. Also, sending the IRQ based on the timing window being greater than the threshold time may comprise: transmitting, to a central processing unit (CPU), the IRQ based on the timing window being greater than the threshold time.

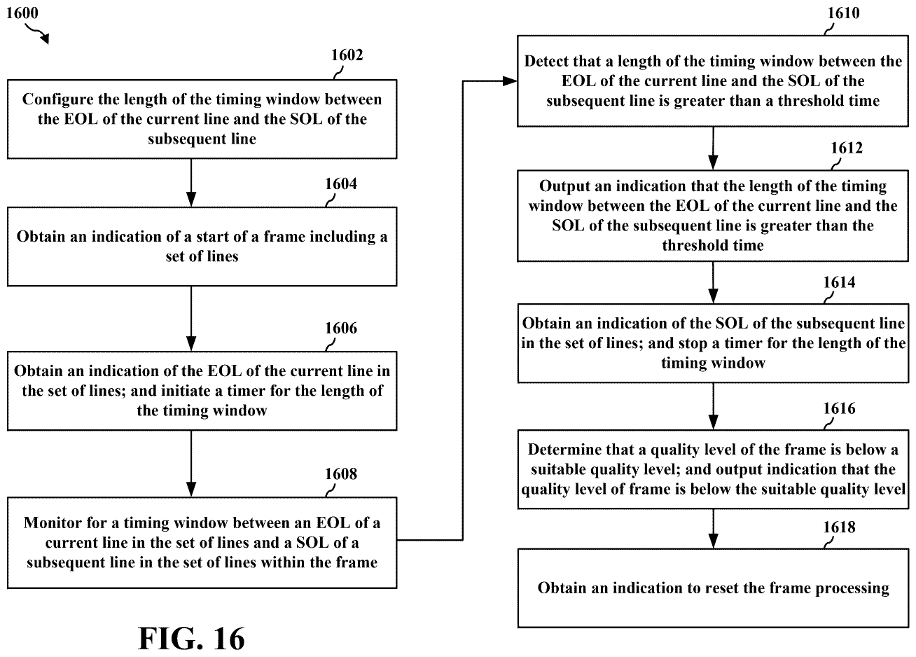

FIG. 16 is a flowchart 1600 of an example method of communication in accordance with one or more techniques of this disclosure. The method may be performed by an SoC (e.g., an SoC, a camera serial interface (CSI) receiver, an application processor (AP), a safety monitor, a safety controller, a controller, a safety system, a safety component, an automotive component, an automotive system, a system, a component, or any apparatus that may perform communication), a device (e.g., the UE 104, a device that includes the SoC 1402, the apparatus 1704), a display driver integrated circuit (DDIC), an apparatus for communication, a wireless communication device, and/or any apparatus that may perform communication as used in connection with the examples of FIGS. 1-14.

At 1602, the SoC configure the length of the timing window between the EOL of the current line and the SOL of the subsequent line, as described in connection with the examples in FIGS. 1-14. For example, as described in 1410 of FIG. 14, SoC 1402 may configure the length of the timing window between the EOL of the current line and the SOL of the subsequent line. Further, step 1602 may be performed by detection component 198 in FIG. 1. In some aspects, configuring the length of the timing window may comprise: maintaining the length of the timing window or adjusting the length of the timing window.

At 1604, the SoC may obtain an indication of a start of a frame including a set of lines, where the set of lines is associated with frame processing for the frame, as described in connection with the examples in FIGS. 1-14. For example, as described in 1420 of FIG. 14, SoC 1402 may obtain an indication of a start of a frame including a set of lines, where the set of lines is associated with frame processing for the frame. Further, step 1604 may be performed by detection component 198 in FIG. 1. For example, SoC 1402 may obtain indication 1422 from component 1404. In some aspects, obtaining the indication of the frame including the set of lines may comprise: receiving, at a camera serial interface (CSI) receiver in a system-on-chip (SoC), the indication of the frame including the set of lines. Additionally, the frame may be a camera frame in a set of camera frames for a camera, and the camera may be part of a set of cameras that are located within a device or a vehicle. Further, the indication of the start of the frame may be a start-of-frame (SOF) indication or a frame start (FS) indication.

At 1606, the SoC obtain an indication of the EOL of the current line in the set of lines; and initiate a timer for the length of the timing window upon obtainment of the indication of the EOL of the current line, as described in connection with the examples in FIGS. 1-14. For example, as described in 1430 of FIG. 14, SoC 1402 may obtain an indication of the EOL of the current line in the set of lines; and initiate a timer for the length of the timing window upon obtainment of the indication of the EOL of the current line. Further, step 1606 may be performed by detection component 198 in FIG. 1. For example, SoC 1402 may obtain indication 1432 from component 1404. Also, at 1430, SoC 1402 may determine that the timer for the length of the timing window has expired based on the length of the timing window being greater than the threshold time; and reset the timer based on the determination that the timer for the length of the timing window has expired.

At 1608, the SoC monitor for a timing window between an end-of-line (EOL) of a current line in the set of lines and a start-of-line (SOL) of a subsequent line in the set of lines within the frame, where the subsequent line is after the current line in the set of lines, as described in connection with the examples in FIGS. 1-14. For example, as described in 1440 of FIG. 14, SoC 1402 may monitor for a timing window between an end-of-line (EOL) of a current line in the set of lines and a start-of-line (SOL) of a subsequent line in the set of lines within the frame, where the subsequent line is after the current line in the set of lines. Further, step 1608 may be performed by detection component 198 in FIG. 1.

At 1610, the SoC detect that a length of the timing window between the EOL of the current line and the SOL of the subsequent line is greater than a threshold time, as described in connection with the examples in FIGS. 1-14. For example, as described in 1450 of FIG. 14, SoC 1402 may detect that a length of the timing window between the EOL of the current line and the SOL of the subsequent line is greater than a threshold time. Further, step 1610 may be performed by detection component 198 in FIG. 1. In some aspects, detecting that the length of the timing window is greater than the threshold time may comprise: detecting, at a system-on-chip (SoC), that the length of the timing window is greater than the threshold time. Detecting, at the SoC, that the length of the timing window is greater than the threshold time may comprise: detecting, at a camera serial interface (CSI) receiver in the SoC, that the length of the timing window is greater than the threshold time. Further, detecting, at the SoC, that the length of the timing window is greater than the threshold time may comprise: detecting that a timer for the length of the timing window has expired, where a length of the timer is equal to the threshold time. In some aspects, detecting that the timer for the length of the timing window has expired may comprise: determining that an indication of the SOL of the subsequent line is not received within the threshold time. In some instances, the length of the timing window between the EOL of the current line and the SOL of the subsequent line may be a horizontal blanking interval (HBI).

At 1612, the SoC output an indication that the length of the timing window between the EOL of the current line and the SOL of the subsequent line is greater than the threshold time, as described in connection with the examples in FIGS. 1-14. For example, as described in 1460 of FIG. 14, SoC 1402 may output an indication that the length of the timing window between the EOL of the current line and the SOL of the subsequent line is greater than the threshold time. Further, step 1612 may be performed by detection component 198 in FIG. 1. In some aspects, outputting the indication that the length of the timing window between the EOL of the current line and the SOL of the subsequent line is greater than the threshold time may comprise: transmitting the indication that the length of the timing window between the EOL of the current line and the SOL of the subsequent line is greater than the threshold time. For example, SoC 1402 may transmit indication 1462 to component 1404. Also, outputting the indication that the length of the timing window between the EOL of the current line and the SOL of the subsequent line is greater than the threshold time may comprise: storing the indication that the length of the timing window between the EOL of the current line and the SOL of the subsequent line is greater than the threshold time. For example, SoC 1402 may store indication 1464 in memory 1406. In some aspects, outputting the indication that the timing window is greater than the threshold time may comprise: sending an interrupt request (IRQ) based on the timing window being greater than the threshold time. Also, sending the IRQ based on the timing window being greater than the threshold time may comprise: transmitting, to a central processing unit (CPU), the IRQ based on the timing window being greater than the threshold time.

At 1614, the SoC obtain an indication of the SOL of the subsequent line in the set of lines; and stop a timer for the length of the timing window based on the indication of the SOL of the subsequent line in the set of lines, as described in connection with the examples in FIGS. 1-14. For example, as described in 1470 of FIG. 14, SoC 1402 may obtain an indication of the SOL of the subsequent line in the set of lines; and stop a timer for the length of the timing window based on the indication of the SOL of the subsequent line in the set of lines. Further, step 1614 may be performed by detection component 198 in FIG. 1. For example, SoC 1402 may obtain indication 1472 from component 1404.

At 1616, the SoC determine that a quality level of the frame is below a suitable quality level; and output an indication that the quality level of the frame is below the suitable quality level based on the timing window between the EOL of the current line and the SOL of the subsequent line being greater than the threshold time, as described in connection with the examples in FIGS. 1-14. For example, as described in 1480 of FIG. 14, SoC 1402 may determine that a quality level of the frame is below a suitable quality level; and output an indication that the quality level of the frame is below the suitable quality level based on the timing window between the EOL of the current line and the SOL of the subsequent line being greater than the threshold time. Further, step 1616 may be performed by detection component 198 in FIG. 1. For example, SoC 1402 may output indication 1482 to component 1404 or memory 1406.

At 1618, the SoC obtain an indication to reset the frame processing based on the timing window between the EOL of the current line and the SOL of the subsequent line being greater than the threshold time, as described in connection with the examples in FIGS. 1-14. For example, as described in 1490 of FIG. 14, SoC 1402 may obtain an indication to reset the frame processing based on the timing window between the EOL of the current line and the SOL of the subsequent line being greater than the threshold time. Further, step 1618 may be performed by detection component 198 in FIG. 1. For example, SoC 1402 may obtain indication 1492 from component 1404. Also, at 1490, SoC 1402 may obtain an indication of a start of a subsequent frame including a set of subsequent lines, where the subsequent frame is after the frame; and monitor for a second timing window between an EOL of a second current line in the set of subsequent lines and a SOL of a second subsequent line in the set of subsequent lines, where the second subsequent line is after the second current line in the set of lines.

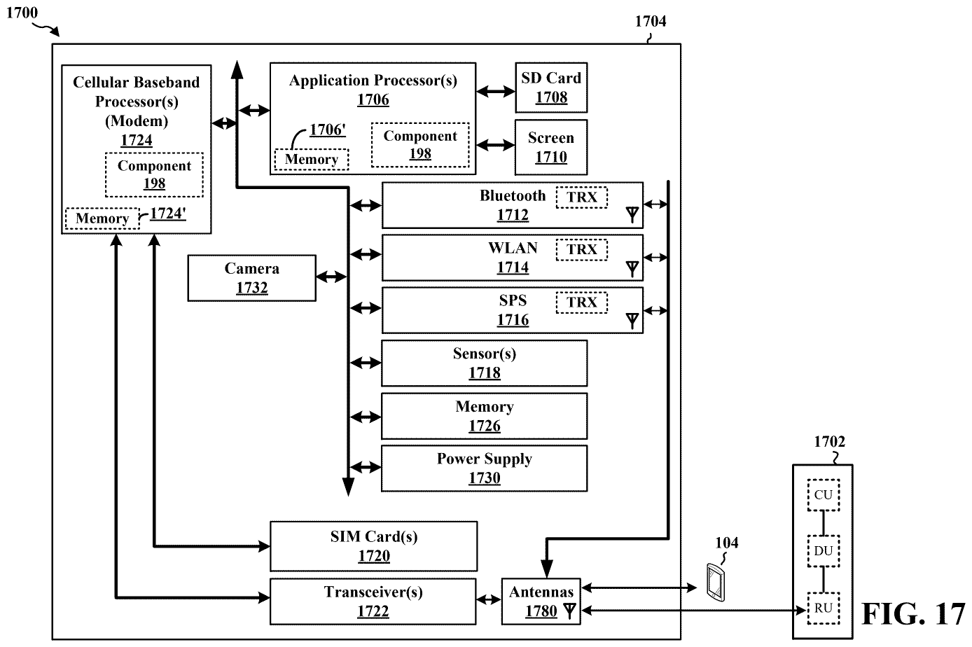

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include at least one cellular baseband processor 1724 (also referred to as a modem) coupled to one or more transceivers 1722 (e.g., cellular RF transceiver). The cellular baseband processor(s) 1724 may include at least one on-chip memory 1724′. In some aspects, the apparatus 1704 may further include one or more subscriber identity modules (SIM) cards 1720 and at least one application processor 1706 coupled to a secure digital (SD) card 1708 and a screen 1710. The application processor(s) 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); ranging devices, magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor(s) 1724 communicates through the transceiver(s) 1722 via one or more antennas 1780 with the UE 104 and/or with an RU associated with a network entity 1702. The cellular baseband processor(s) 1724 and the application processor(s) 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor(s) 1724 and the application processor(s) 1706 are each responsible for general processing, including the execution of software stored on the computer-readable medium/memory. The software, when executed by the cellular baseband processor(s) 1724/application processor(s) 1706, causes the cellular baseband processor(s) 1724/application processor(s) 1706 to perform the various functions described supra. The computer-readable medium/memory may also be used for storing data that is manipulated by the cellular baseband processor(s) 1724/application processor(s) 1706 when executing software. The cellular baseband processor(s) 1724/application processor(s) 1706 may be a component of the UE 350 and may include the at least one memory 360 and/or at least one of the TX processor 368, the RX processor 356, and the controller/processor 359. In one configuration, the apparatus 1704 may be at least one processor chip (modem and/or application) and include just the cellular baseband processor(s) 1724 and/or the application processor(s) 1706, and in another configuration, the apparatus 1704 may be the entire UE (e.g., see UE 350 of FIG. 3) and include the additional modules of the apparatus 1704.

As discussed supra, the detection component 198 may be configured to obtain an indication of a start of a frame including a set of lines, where the set of lines is associated with frame processing for the frame. In some aspects, the detection component 198 may be further configured to monitor for a timing window between an end-of-line (EOL) of a current line in the set of lines and a start-of-line (SOL) of a subsequent line in the set of lines within the frame, where the subsequent line is after the current line in the set of lines. In some aspects, the detection component 198 may be further configured to detect that a length of the timing window between the EOL of the current line and the SOL of the subsequent line is greater than a threshold time. In some aspects, the detection component 198 may be further configured to output an indication that the length of the timing window between the EOL of the current line and the SOL of the subsequent line is greater than the threshold time. In some aspects, the detection component 198 may be further configured to obtain an indication of the EOL of the current line in the set of lines; and initiate a timer for the length of the timing window upon obtainment of the indication of the EOL of the current line. In some aspects, the detection component 198 may be further configured to determine that a quality level of the frame is below a suitable quality level; and output an indication that the quality level of the frame is below the suitable quality level based on the timing window between the EOL of the current line and the SOL of the subsequent line being greater than the threshold time. In some aspects, the detection component 198 may be further configured to obtain an indication to reset the frame processing based on the timing window between the EOL of the current line and the SOL of the subsequent line being greater than the threshold time. In some aspects, the detection component 198 may be further configured to obtain an indication of the SOL of the subsequent line in the set of lines; and stop a timer for the length of the timing window based on the indication of the SOL of the subsequent line in the set of lines. In some aspects, the detection component 198 may be further configured to configure the length of the timing window between the EOL of the current line and the SOL of the subsequent line. The detection component 198 may be within the cellular baseband processor(s) 1724, the application processor(s) 1706, or both the cellular baseband processor(s) 1724 and the application processor(s) 1706. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1704 may include a variety of components configured for various functions. In one configuration, the apparatus 1704, and in particular the cellular baseband processor(s) 1724 and/or the application processor(s) 1706, may include means for obtaining an indication of a start of a frame including a set of lines, where the set of lines is associated with frame processing for the frame. In some aspects, the apparatus 1704 may also include means for monitoring for a timing window between an end-of-line (EOL) of a current line in the set of lines and a start-of-line (SOL) of a subsequent line in the set of lines within the frame, where the subsequent line is after the current line in the set of lines. In some aspects, the apparatus 1704 may also include means for detecting that a length of the timing window between the EOL of the current line and the SOL of the subsequent line is greater than a threshold time. In some aspects, the apparatus 1704 may also include means for outputting an indication that the length of the timing window between the EOL of the current line and the SOL of the subsequent line is greater than the threshold time. In some aspects, the apparatus 1704 may also include means for obtaining an indication of the EOL of the current line in the set of lines; and means for initiating a timer for the length of the timing window upon obtainment of the indication of the EOL of the current line. In some aspects, the apparatus 1704 may also include means for determining that a quality level of the frame is below a suitable quality level; and means for outputting an indication that the quality level of the frame is below the suitable quality level based on the timing window between the EOL of the current line and the SOL of the subsequent line being greater than the threshold time. In some aspects, the apparatus 1704 may also include means for obtaining an indication to reset the frame processing based on the timing window between the EOL of the current line and the SOL of the subsequent line being greater than the threshold time. In some aspects, the apparatus 1704 may also include means for obtaining an indication of the SOL of the subsequent line in the set of lines; and means for stopping a timer for the length of the timing window based on the indication of the SOL of the subsequent line in the set of lines. In some aspects, the apparatus 1704 may also include means for configuring the length of the timing window between the EOL of the current line and the SOL of the subsequent line. The means may be the component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for communication, including at least one memory and at least one processor coupled to the at least one memory and, based at least in part on information stored in the at least one memory, the at least one processor, individually or in any combination, is configured to: obtain an indication of a start of a frame including a set of lines, wherein the set of lines is associated with frame processing for the frame; monitor for a timing window between an end-of-line (EOL) of a current line in the set of lines and a start-of-line (SOL) of a subsequent line in the set of lines within the frame, wherein the subsequent line is after the current line in the set of lines; detect that a length of the timing window between the EOL of the current line and the SOL of the subsequent line is greater than a threshold time; and output an indication that the length of the timing window between the EOL of the current line and the SOL of the subsequent line is greater than the threshold time.

Aspect 2 is the apparatus of aspect 1, wherein to detect that the length of the timing window is greater than the threshold time, the at least one processor is configured to: detect, at a system-on-chip (SoC), that the length of the timing window is greater than the threshold time.

Aspect 3 is the apparatus of aspect 2, wherein to detect, at the SoC, that the length of the timing window is greater than the threshold time, the at least one processor is configured to: detect, at a camera serial interface (CSI) receiver in the SoC, that the length of the timing window is greater than the threshold time.

Aspect 4 is the apparatus of any of aspects 2 to 3, wherein to detect, at the SoC, that the length of the timing window is greater than the threshold time, the at least one processor is configured to: detect that a timer for the length of the timing window has expired, wherein a length of the timer is equal to the threshold time.

Aspect 5 is the apparatus of aspect 4, wherein to detect that the timer for the length of the timing window has expired, the at least one processor is configured to: determine that an indication of the SOL of the subsequent line is not received within the threshold time.

Aspect 6 is the apparatus of any of aspects 1 to 5, wherein the length of the timing window between the EOL of the current line and the SOL of the subsequent line is a horizontal blanking interval (HBI).

Aspect 7 is the apparatus of any of aspects 1 to 6, wherein to output the indication that the timing window is greater than the threshold time, the at least one processor is configured to: send an interrupt request (IRQ) based on the timing window being greater than the threshold time.

Aspect 8 is the apparatus of aspect 7, wherein to send the IRQ based on the timing window being greater than the threshold time, the at least one processor is configured to: transmit, to a central processing unit (CPU), the IRQ based on the timing window being greater than the threshold time.

Aspect 9 is the apparatus of any of aspects 1 to 8, wherein the at least one processor is further configured to: obtain an indication of the EOL of the current line in the set of lines; and initiate a timer for the length of the timing window upon obtainment of the indication of the EOL of the current line.

Aspect 10 is the apparatus of aspect 9, wherein the at least one processor is further configured to: determine that the timer for the length of the timing window has expired based on the length of the timing window being greater than the threshold time; and reset the timer based on the determination that the timer for the length of the timing window has expired.

Aspect 11 is the apparatus of any of aspects 1 to 10, wherein the at least one processor is further configured to: determine that a quality level of the frame is below a suitable quality level; and output an indication that the quality level of the frame is below the suitable quality level based on the timing window between the EOL of the current line and the SOL of the subsequent line being greater than the threshold time.

Aspect 12 is the apparatus of any of aspects 10 to 11, wherein the at least one processor is further configured to: obtain an indication to reset the frame processing based on the timing window between the EOL of the current line and the SOL of the subsequent line being greater than the threshold time.

Aspect 13 is the apparatus of aspect 12, wherein the at least one processor is further configured to: obtain an indication of a start of a subsequent frame including a set of subsequent lines, wherein the subsequent frame is after the frame; and monitor for a second timing window between an EOL of a second current line in the set of subsequent lines and a SOL of a second subsequent line in the set of subsequent lines, wherein the second subsequent line is after the second current line in the set of lines.

Aspect 14 is the apparatus of any of aspects 1 to 13, wherein the at least one processor is further configured to: obtain an indication of the SOL of the subsequent line in the set of lines; and stop a timer for the length of the timing window based on the indication of the SOL of the subsequent line in the set of lines.

Aspect 15 is the apparatus of any of aspects 1 to 14, wherein the at least one processor is further configured to: configure the length of the timing window between the EOL of the current line and the SOL of the subsequent line.

Aspect 16 is the apparatus of aspect 15, wherein to configure the length of the timing window, the at least one processor is configured to: maintain the length of the timing window or adjusting the length of the timing window.

Aspect 17 is the apparatus of any of aspects 1 to 16, wherein to obtain the indication of the frame including the set of lines, the at least one processor is configured to: receive, at a camera serial interface (CSI) receiver in a system-on-chip (SoC), the indication of the frame including the set of lines.

Aspect 18 is the apparatus of any of aspects 1 to 17, wherein the frame is a camera frame in a set of camera frames for a camera, wherein the camera is part of a set of cameras that are located within a device or a vehicle.

Aspect 19 is the apparatus of any of aspects 1 to 18, wherein the indication of the start of the frame is a start-of-frame (SOF) indication or a frame start (FS) indication.

Aspect 20 is the apparatus of any of aspects 1 to 19, wherein to output the indication that the length of the timing window between the EOL of the current line and the SOL of the subsequent line is greater than the threshold time, the at least one processor is configured to: transmit the indication that the length of the timing window between the EOL of the current line and the SOL of the subsequent line is greater than the threshold time; or store the indication that the length of the timing window between the EOL of the current line and the SOL of the subsequent line is greater than the threshold time.

Aspect 21 is the apparatus of aspect 20, further including (i.e., comprising) at least one of an antenna or a transceiver coupled to the at least one processor, wherein to transmit the indication that the length of the timing window between the EOL of the current line and the SOL of the subsequent line is greater than the threshold time, the at least one processor is configured to: transmit, via at least one of an antenna or a transceiver, the indication that the length of the timing window between the EOL of the current line and the SOL of the subsequent line is greater than the threshold time.

Aspect 22 is the apparatus of any of aspects 1 to 21, wherein the apparatus is a wireless communication device.

Aspect 23 is a method of communication for implementing any of aspects 1 to 21.

Aspect 24 is an apparatus for communication including means for implementing any of aspects 1 to 21.

Aspect 25 is a computer-readable medium (e.g., a non-transitory computer-readable medium) storing computer executable code (e.g., code for communication), the code when executed by at least one processor causes the at least one processor to implement any of aspects 1 to 21.

What is claimed is:

1. An apparatus for communication, comprising:
at least one memory; and
at least one processor coupled to the at least one memory and, based at least in part on information stored in the at least one memory, the at least one processor is configured to:
obtain an indication of a start of a frame including a set of lines, wherein the set of lines is associated with frame processing for the frame;
monitor for a timing window between an end-of-line (EOL) of a current line in the set of lines and a start-of-line (SOL) of a subsequent line in the set of lines within the frame, wherein the subsequent line is after the current line in the set of lines;
detect that a length of the timing window between the EOL of the current line and the SOL of the subsequent line is greater than a threshold time; and
output an indication that the length of the timing window between the EOL of the current line and the SOL of the subsequent line is greater than the threshold time.

2. The apparatus of claim 1, wherein to detect that the length of the timing window is greater than the threshold time, the at least one processor is configured to:
detect, at a system-on-chip (SoC), that the length of the timing window is greater than the threshold time.

3. The apparatus of claim 2, wherein to detect, at the SoC, that the length of the timing window is greater than the threshold time, the at least one processor is configured to:
detect, at a camera serial interface (CSI) receiver in the SoC, that the length of the timing window is greater than the threshold time.

4. The apparatus of claim 2, wherein to detect, at the SoC, that the length of the timing window is greater than the threshold time, the at least one processor is configured to:
detect that a timer for the length of the timing window has expired, wherein a length of the timer is equal to the threshold time.

5. The apparatus of claim 4, wherein to detect that the timer for the length of the timing window has expired, the at least one processor is configured to:
determine that an indication of the SOL of the subsequent line is not received within the threshold time.

6. The apparatus of claim 1, wherein the length of the timing window between the EOL of the current line and the SOL of the subsequent line is a horizontal blanking interval (HBI).

7. The apparatus of claim 1, wherein to output the indication that the timing window is greater than the threshold time, the at least one processor is configured to:
send an interrupt request (IRQ) based on the timing window being greater than the threshold time.

8. The apparatus of claim 7, wherein to send the IRQ based on the timing window being greater than the threshold time, the at least one processor is configured to:
transmit, to a central processing unit (CPU), the IRQ based on the timing window being greater than the threshold time.

9. The apparatus of claim 1, wherein the at least one processor is further configured to:
obtain an indication of the EOL of the current line in the set of lines; and
initiate a timer for the length of the timing window upon obtainment of the indication of the EOL of the current line.

10. The apparatus of claim 9, wherein the at least one processor is further configured to:
determine that the timer for the length of the timing window has expired based on the length of the timing window being greater than the threshold time; and
reset the timer based on the determination that the timer for the length of the timing window has expired.

11. The apparatus of claim 1, wherein the at least one processor is further configured to:
determine that a quality level of the frame is below a suitable quality level; and
output an indication that the quality level of the frame is below the suitable quality level based on the timing window between the EOL of the current line and the SOL of the subsequent line being greater than the threshold time.

12. The apparatus of claim 1, wherein the at least one processor is further configured to:
obtain an indication to reset the frame processing based on the timing window between the EOL of the current line and the SOL of the subsequent line being greater than the threshold time.

13. The apparatus of claim 12, wherein the at least one processor is further configured to:
obtain an indication of a start of a subsequent frame including a set of subsequent lines, wherein the subsequent frame is after the frame; and
monitor for a second timing window between an EOL of a second current line in the set of subsequent lines and a SOL of a second subsequent line in the set of subsequent lines, wherein the second subsequent line is after the second current line in the set of lines.

14. The apparatus of claim 1, wherein the at least one processor is further configured to:
obtain an indication of the SOL of the subsequent line in the set of lines; and
stop a timer for the length of the timing window based on the indication of the SOL of the subsequent line in the set of lines.

15. The apparatus of claim 1, wherein the at least one processor is further configured to:
configure the length of the timing window between the EOL of the current line and the SOL of the subsequent line.

16. The apparatus of claim 15, wherein to configure the length of the timing window, the at least one processor is configured to:
maintain the length of the timing window or adjusting the length of the timing window.

17. The apparatus of claim 1, wherein to obtain the indication of the frame including the set of lines, the at least one processor is configured to:
receive, at a camera serial interface (CSI) receiver in a system-on-chip (SoC), the indication of the frame including the set of lines.

18. The apparatus of claim 1, wherein the frame is a camera frame in a set of camera frames for a camera, wherein the camera is part of a set of cameras that are located within a device or a vehicle, and wherein the indication of the start of the frame is a start-of-frame (SOF) indication or a frame start (FS) indication.

19. A method of communication, comprising:
obtaining an indication of a start of a frame including a set of lines, wherein the set of lines is associated with frame processing for the frame;
monitoring for a timing window between an end-of-line (EOL) of a current line in the set of lines and a start-of-line (SOL) of a subsequent line in the set of lines within the frame, wherein the subsequent line is after the current line in the set of lines;
detecting that a length of the timing window between the EOL of the current line and the SOL of the subsequent line is greater than a threshold time; and
outputting an indication that the length of the timing window between the EOL of the current line and the SOL of the subsequent line is greater than the threshold time.

20. A computer-readable medium storing computer executable code for communication, the code when executed by at least one processor causes the at least one processor to:
obtain an indication of a start of a frame including a set of lines, wherein the set of lines is associated with frame processing for the frame;
monitor for a timing window between an end-of-line (EOL) of a current line in the set of lines and a start-of-line (SOL) of a subsequent line in the set of lines within the frame, wherein the subsequent line is after the current line in the set of lines;
detect that a length of the timing window between the EOL of the current line and the SOL of the subsequent line is greater than a threshold time; and
output an indication that the length of the timing window between the EOL of the current line and the SOL of the subsequent line is greater than the threshold time.
